(19) United States
(12) Patent Application Publication
(10) Pub. No.: US 2014/0344034 A1
(43) Pub. Date: Nov. 20, 2014

(54) PLATFORMS, SYSTEMS, AND METHODS FOR PROVIDING ALTERNATIVE ACCESS TO GOODS AND SERVICES THROUGH INTERACTION WITH AD-BASED GAMES

(71) Applicant: Unlockable, Inc., New York, NY (US)

(72) Inventors: Zachary Goodman, New York, NY (US); Christopher Bian, Brooklyn, NY (US); Ben Beecher, Brooklyn, NY (US); Francesco Marconi, New York, NY (US)

(73) Assignee: Unlockable, Inc., New York, NY (US)

(21) Appl. No.: 14/280,442

(22) Filed: May 16, 2014

Related U.S. Application Data
(60) Provisional application No. 61/824,315, filed on May 16, 2013.

(51) Int. Cl. G06Q 30/02

(52) U.S. Cl. CPC G06Q 30/0209; G06Q 30/0241
USPC 705/14.12

(57) ABSTRACT

Computer-based platforms, systems, and methods as well as software applications for providing non-currency alternatives to access goods, services, and/or information through interaction with ad-based games.

### CROSS REFERENCE TO RELATED APPLICATIONS

This application claims the benefit of U.S. Application Ser. No. 61/824,315, filed May 16, 2013, which is hereby incorporated by reference in its entirety.

### BACKGROUND OF THE INVENTION

Advertising is traditionally used to encourage or persuade an audience to continue or take some new action. Most commonly, the desired result is to drive consumer behavior with respect to a commercial offering. Perhaps the fastest growing segment of the advertising industry is online and mobile advertising. Spending on online advertising topped $100 billion for the first time in 2012, according to a report from eMarketer. Examples of online advertising include contextual ads on search engine results pages, banner ads, blogs, rich media ads, social network advertising, interstitial ads, online classified advertising, advertising networks, dynamic banner ads, cross-platform ads, and e-mail marketing. Online advertising offers the advantage of immediate publishing of information and content that is not limited by geography or time.

### SUMMARY OF THE INVENTION

Current online advertising does not adequately capture and hold the attention of viewers. In other words, user engagement is not adequate. Moreover, online ads drive user to content, but online publishers offer the vast majority of their content for free. Many online media publishers sell access to content to as little as 5% of their users, with as much as 95% consuming content without monetization.

The platforms, systems, media, and methods described herein turn advertising into games. Consumers (e.g., users or viewers) play the games to unlock and access digital content for free, as a non-currency alternative to payment. Advantages of the platforms, systems, media, and methods described herein include, but are not limited to, improved user engagement with ad content including video-based ads, wherein users choose when to see advertising, have fun with advertising, and get real value from advertising. The platforms, systems, media, and methods described herein create advantages for each party involved with the advertising cycle. Brands get guaranteed user engagement and valuable user data from the ads they have already made, publishers get simple drop-in premium ad inventory, and players get a free and fun way to access content they would otherwise have to pay for.

Importantly, the platforms, systems, media, and methods described herein connect premium online content with the users who want it, but are unable or unwilling to pay for it in traditional modes of commerce.

In one aspect, disclosed herein are computer-implemented systems comprising: a digital processing device comprising an operating system configured to perform executable instructions and a memory device; a computer program including instructions executable by the digital processing device to create an application for providing a non-currency alternative to access goods, services, or information comprising: a software module configured to receive input from a user identifying a particular good, service, or information and indicating a request to access the particular good, service, or information via a non-currency alternative payment method; a software module configured to select a game from a database of games, the game based on an ad; a software module configured to present the game to the user and track the user's game play; and a software module configured to provide access to the good, service, or information in response to the user's game play achieving one or more completion criteria. In some embodiments, the one or more completion criteria comprise: earning a minimum number of points, playing or completing a minimum number of games, or being randomly rewarded an instant win. In some embodiments, the ad comprises video. In other embodiments, the ad comprises one or more images. In some embodiments, the application further comprises a database of ads. In some embodiments, the application further comprises a software module configured to create a game by applying a game template to ad media. In some embodiments, the game comprises an interactive ad. In some embodiments, the goal of the game comprises user demonstration of retention of the content of the ad. In further embodiments, the retention is assessed by one or more of: answering trivia questions about the content of the ad; sequencing images captured from the content of the ad; matching sound clips to animations or video clips captured from the ad; connecting pieces of playing video together; guiding falling pieces of playing video into the correct positions; rearranging various shapes of video into the proper configuration; selecting predetermined images within the video as the video plays; and clicking or tapping the video after hearing an audio cue. In some embodiments, the good, service, or information comprises one or more songs, videos, movies, books, magazines, articles, TV shows, software applications, virtual goods, virtual currency, discounts, coupons, physical goods, or a combination thereof. In some embodiments, the good, service, or information comprises a subscription or portion of a subscription cost for a media provider. In further embodiments, the media provider is a mobile/tablet application provider, mobile/tablet game provider, cable provider, telecom provider, wireless service provider, broadcast network provider, digital video provider, digital music provider, digital radio provider, terrestrial radio provider, premium channel provider, news editorial provider, magazine editorial provider, ebook provider, subscription provider, or service provider. In some embodiments, the ad or the game is selected based on collected data. In further embodiments, the collected data comprises on one or more of: user demographic; environment from which the user requested access to the particular good, service, or information; user behavioral action including app downloads, web browsing history, purchase history, coupon redemptions, or engagement with particular media; attributes or metadata of a particular video ad, the attributes or metadata comprising length, subject matter, or content; external, third party data sources selected from: publicly available information, social networks, shopper loyalty programs, data vendors, and proprietary data companies; user survey results; and user historical game play. In some embodiments, the software module configured to present the game to the user and track the user's game play tracks number of plays, time, score, accumulated value, and answers to survey questions posed during game play. In some embodiments, the application further comprises a software module configured to award points or tokens for the user's game play. In some embodiments, the application further comprises a software module configured to create a playlist of games, the playlist comprising a sequence of games, each game selected for the user. In some embodiments, the processing device is a public kiosk, a media rental machine, a vehicle, a taxi passenger display, an airplane seatback device, an in-vehicle video display, an internet-enabled appliance, an internet-enabled television, or an automated bank teller machine (ATM).

In another aspect, disclosed herein are non-transitory computer-readable storage media encoded with a computer program including instructions executable by a processor to create an application for providing a non-currency alternative to access goods, services, or information comprising: a software module configured to receive input from a user identifying a particular good, service, or information and indicating a request to access the particular good, service, or information via a non-currency alternative payment method; a software module configured to select a game from a database of games, the game based on an ad; a software module configured to present the game to the user and track the user's game play; and a software module configured to provide access to the good, service, or information in response to the user's game play achieving one or more completion criteria. In some embodiments, the application further comprises a software module configured to create a playlist of games, the playlist comprising a sequence of games, each game selected for the user.

In another aspect, disclosed herein are computer-implemented methods for providing access to goods, services, or information via a non-currency alternative payment method comprising: receiving, by a computer, input from a user identifying a particular good, service, or information and indicating a request to access the particular good, service, or information via a non-currency alternative payment method; selecting, by the computer, a game from a database of games, the game based on an ad; presenting, by the computer, the game to the user and track the user's game play; and providing, by the computer, access to the good, service, or information in response to the user's game play achieving one or more completion criteria. In some embodiments, the method further comprises creating, by the computer, a playlist of games, the playlist comprising a sequence of games, each game selected for the user.

In another aspect, disclosed herein are non-transitory computer-readable storage media encoded with a computer program including instructions executable by a processor to create an application for providing a non-currency alternative to access goods, services, or information comprising: a software module configured to receive input from a user indicating a request to access a particular good, service, or information; a software module configured to select a game from a database of games, the game based on an ad; a software module configured to present the game to the user and track the user's game play; and a software module configured to provide access to the good, service, or information, the access provided when the user's game play achieves a threshold value. In some embodiments, the ad pertains to the particular good, service, or information. In further embodiments, the ad is for the particular good, service, or information. In other embodiments, the ad is for a product related to the particular good, service, or information. In other embodiments, the ad is for a product unrelated to the particular good, service, or information. In some embodiments, the ad comprises video. In some embodiments, the application further comprises a database of ads. In some embodiments, the application further comprises a software module configured to create a game by applying a game template to ad media. In further embodiments, game creation is automated. In other embodiments, game creation requires manual content management. In some embodiments, the game comprises an interactive ad. In some embodiments, the goal of the game comprises user demonstration of understanding of the subject matter of the ad. In some embodiments, the game comprises trivia from the ad. In some embodiments, the game comprises sequencing images captured from the ad. In some embodiments, the game comprises breaking a video into segments that the user reassembles during playback of an ad video. In some embodiments, the game comprises segments of an ad video falling from the top of the screen to a container, wherein the user clicks or touches the screen to guide the segments into the correct order. In some embodiments, the game comprises objects the user is instructed to click or touch as they appear during playback of an ad video. In some embodiments, the game comprises a list of words or sounds, wherein the user is instructed to click or touch the screen when he or she hears those words or sounds. In some embodiments, the game comprises matching audio segments to the proper silent ad video segment. In some embodiments, the game comprises identifying an ad video from its audio track. In some embodiments, the game comprises identifying a brand during playback of an ad video. In some embodiments, the game comprises a series of ad video segments that the user must identify by brand or product. In some embodiments, the game comprises syncing clicks or touches with specified time points during playback of an ad video. In some embodiments, the good, service, or information comprises one or more songs, videos, movies, books, magazines, articles, TV shows, software applications, virtual goods, virtual currency, discounts, coupons, or a combination thereof. In some embodiments, the good, service, or information comprises one or more physical goods. In some embodiments, the good, service, or information comprises a subscription or portion of a subscription cost for a media provider. In some embodiments, the ad or the game is selected based on one or more of: demographic of the user, environment from which the user requested access to a particular good, service, or information, user behavioral actions, user survey results, and user historical game play. In some embodiments, the software module configured to track the user's game play tracks one or more of: number of plays, time, score, and accumulated value. In some embodiments, the software module configured to track the user's game play tracks one or more user demographic or user behavioral parameters. In some embodiments, game play value is represented by points or tokens. In further embodiments, the application further comprises a software module configured to award points or tokens for the user's game play. In still further embodiments, the points or tokens are redeemable for rewards associated with the subject matter of the ad. In still further embodiments, the software module configured to award points or tokens for the user's game play tracks the user's point or token total. In some embodiments, the application further comprises a software module configured to present a catalog of rewards, wherein game play value is redeemable for rewards, the rewards in some embodiments associated with the subject matter of the ad, and in other embodiments unrelated to the subject matter of the ad. In some embodiments, the application further comprises a software module configured to create a playlist of games, the playlist comprising a sequence of games, each game selected for the user. In some embodiments, the application is implemented as a web application, a web browser plug-in, a mobile application, a standalone application, a set-top application, a console game application, or a combination thereof. In some embodiments, the application is implemented in a public kiosk, a media rental machine, a vehicle, a taxi passenger display, an airplane seatback device, an internet-enabled appliance, an internet-enabled television, or an automated bank teller machine.

In another aspect, disclosed herein are computer-implemented systems comprising: a digital processing device comprising an operating system configured to perform executable instructions and a memory device; a computer program including instructions executable by the digital processing device to create an application for providing a non-currency alternative to access goods, services, or information comprising: a software module configured to receive input from a user indicating a request to access a particular good, service, or information; a software module configured to select a game from a database of games, the game based on an ad; a software module configured to present the game to the user and track the user's game play; and a software module configured to provide access to the good, service, or information, the access provided when the user's game play achieves a threshold value. In some embodiments, the ad pertains to the particular good, service, or information. In further embodiments, the ad is for the particular good, service, or information. In other embodiments, the ad is for a product related to the particular good, service, or information. In other embodiments, the ad is for a product unrelated to the particular good, service, or information. In some embodiments, the ad comprises video. In some embodiments, the application further comprises a database of ads. In some embodiments, the application further comprises a software module configured to create a game by applying a game template to ad media. In further embodiments, game creation is automated. In other embodiments, game creation requires manual content management. In some embodiments, the game comprises an interactive ad. In some embodiments, the goal of the game comprises user demonstration of understanding of the subject matter of the ad. In some embodiments, the game comprises trivia from the ad. In some embodiments, the game comprises sequencing images captured from the ad. In some embodiments, the game comprises breaking a video into segments that the user reassembles during playback of an ad video. In some embodiments, the game comprises segments of an ad video falling from the top of the screen to a container, wherein the user clicks or touches the screen to guide the segments into the correct order. In some embodiments, the game comprises objects the user is instructed to click or touch as they appear during playback of an ad video. In some embodiments, the game comprises a list of words or sounds, wherein the user is instructed to click or touch the screen when he or she hears those words or sounds. In some embodiments, the game comprises matching audio segments to the proper silent ad video segment. In some embodiments, the game comprises identifying an ad video from its audio track. In some embodiments, the game comprises identifying a brand during playback of an ad video. In some embodiments, the game comprises a series of ad video segments that the user must identify by brand or product. In some embodiments, the game comprises syncing clicks or touches with specified time points during playback of an ad video. In some embodiments, the good, service, or information comprises one or more songs, videos, movies, books, magazines, articles, TV shows, software applications, virtual goods, virtual currency, discounts, coupons, or a combination thereof. In some embodiments, the good, service, or information comprises one or more physical goods. In some embodiments, the good, service, or information comprises a subscription or portion of a subscription cost for a media provider. In some embodiments, the ad or the game is selected based on one or more of: demographic of the user, environment from which the user requested access to a particular good, service, or information, user behavioral actions, user survey results, and user historical game play. In some embodiments, the software module configured to track the user's game play tracks one or more of: number of plays, time, score, and accumulated value. In some embodiments, the software module configured to track the user's game play tracks one or more user demographic or user behavioral parameters. In some embodiments, game play value is represented by points or tokens. In further embodiments, the application further comprises a software module configured to award points or tokens for the user's game play. In still further embodiments, the points or tokens are redeemable for rewards associated with the subject matter of the ad. In still further embodiments, the software module configured to award points or tokens for the user's game play tracks the user's point or token total. In some embodiments, the application further comprises a software module configured to present a catalog of rewards, wherein game play value is redeemable for rewards, the rewards associated with the subject matter of the ad. In some embodiments, the application further comprises a software module configured to create a playlist of games, the playlist comprising a sequence of games, each game selected for the user. In some embodiments, the application is implemented as a web application, a web browser plug-in, a mobile application, a standalone application, a set-top application, a console game application, or a combination thereof. In some embodiments, the processing device is a public kiosk, a media rental machine, a vehicle, a taxi passenger display, an airplane seatback device, an internet-enabled appliance, an internet-enabled television, or an automated bank teller machine.

In another aspect, disclosed herein are computer-implemented methods for providing access to goods, services, or information comprising the steps of: receiving, by a computer, a request from a user for access to a particular good, service, or information; selecting, by the computer, a game from a database of games, the game based on an ad; presenting, by the computer, the game to the user; tracking, by the computer, the user's game play; and providing, by the computer, access to the good, service, or information, the access provided when the user's game play achieves a threshold value. In some embodiments, the ad pertains to the particular good, service, or information. In further embodiments, the ad is for the particular good, service, or information. In other embodiments, the ad is for a product related to the particular good, service, or information. In other embodiments, the ad is for a product unrelated to the particular good, service, or information. In some embodiments, the request from the user is generated from an e-commerce web site, a news web site, a streaming media web site, or a gaming web site. In some embodiments, the request from the user is generated from a mobile device, a subscription television device, a console game system, a public kiosk, a media rental machine, a vehicle, a taxi passenger display, an airplane seatback device, an internet-enabled appliance, an internet-enabled television, or an automated bank teller machine. In some embodiments, the ad comprises video. In some embodiments, the method further comprises the step of applying a game template to an ad, by the computer, to create a game. In some embodiments, the ad is selected from a database of ads. In some embodiments, game creation is automated. In other embodiments, game creation requires manual content management. In some embodiments, the game comprises an interactive ad. In some embodiments, the goal of the game comprises user demonstration of understanding of the subject matter of the ad. In some embodiments, the game comprises trivia from the ad. In some embodiments, the game comprises sequencing images captured from the ad. In some embodiments, the game comprises breaking a video into segments that the user reassembles during playback of an ad video. In some embodiments, the game comprises segments of an ad video falling from the top of the screen to a container, wherein the user clicks or touches the screen to guide the segments into the correct order. In some embodiments, the game comprises objects the user is instructed to click or touch as they appear during playback of an ad video. In some embodiments, the game comprises matching audio segments to the proper silent ad video segment. In some embodiments, the game comprises identifying an ad video from its audio track. In some embodiments, the game comprises identifying a brand during playback of an ad video. In some embodiments, the game comprises a series of ad video segments that the user must identify by brand or product. In some embodiments, the game comprises a list of words or sounds, wherein the user is instructed to click or touch the screen when he or she hears those words or sounds. In some embodiments, the game comprises syncing clicks or touches with specified time points during playback of an ad video. In some embodiments, the good, service, or information comprises one or more songs, videos, movies, books, magazines, articles, TV shows, software applications, virtual goods, virtual currency, discounts, coupons, or a combination thereof. In some embodiments, the good, service, or information comprises one or more physical goods. In some embodiments, the good, service, or information comprises a subscription or portion of a subscription cost for a media provider. In some embodiments, the ad or the game is selected based on one or more of: demographic of the user, environment from which the user requested access to a particular good, service, or information, user behavioral actions, user survey results, and user historical game play. In some embodiments, the method further comprises the step of tracking, by the computer, the user's game play. In further embodiments, one or more of: number of plays, time, score, and accumulated value are tracked. In further embodiments, user demographic or user behavioral parameters are tracked. In some embodiments, game play value is represented by points or tokens. In further embodiments, the method further comprises the step of awarding points or tokens, by the computer, for the user's game play. In still further embodiments, the points or tokens are redeemable for rewards associated with the subject matter of the ad. In some embodiments, the method further comprises the step of presenting, by the computer, a catalog of rewards, wherein game play value is redeemable for rewards, the rewards associated with the subject matter of the ad. In some embodiments, the method further comprises the step of creating, by the computer, a playlist of games, the playlist comprising a sequence of games, each game selected for the user.

### BRIEF DESCRIPTION OF THE DRAWINGS

FIG. 1 shows a non-limiting example of a process flow; in this case, a process for providing a non-currency alternative to access goods, services, or information on the web.

FIG. 2 shows a non-limiting example of a process flow; in this case, a process for matching ads and ad-based games to user profile data and creating sequenced playlists of games tailored to particular users.

FIG. 3 shows a non-limiting example of an introduction screen for games based on an ad pertaining to a particular good, service, or information; in this case, an introduction offering a reward (in the form of tokens) to a user for playing.

FIG. 4 shows a non-limiting view of the game of FIG. 3; in this case, a view of an instruction screen for a trivia game.

FIG. 5 shows a non-limiting view of the game of FIG. 3; in this case, a view of a screen displaying a video-based ad.

FIG. 6 shows a non-limiting view of the game of FIG. 3; in this case, a view of a screen displaying a first trivia question based on the content of the video-based ad as well as four answer options.

FIG. 7 shows a non-limiting view of the game of FIG. 3; in this case, a view of a screen displaying a correct answer option for the first trivia question, as well as an incorrect option selected by the user.

FIG. 8 shows a non-limiting view of the game of FIG. 3; in this case, a view of a screen displaying a trivia question based on the content of the video-based ad as well as a correct answer option.

FIG. 9 shows a non-limiting example of a game based on an ad pertaining to a particular good, service, or information; in this case, a game including an instruction screen for a sorting game.

FIGS. 10-13 show non-limiting views of the game of FIG. 9 including views of frames captured from the video-based ad, wherein the frames are depicted in unsorted, partially sorted, and correctly sorted states based on their order of appearance in the video-based ad.

FIGS. 14-16 show non-limiting views of the game of FIG. 3 including views of screens congratulating a user for completing the trivia game and offering a coupon awarded for game play, wherein the coupon is redeemable for goods related to the subject matter of the video-based ad.

FIG. 17 shows a non-limiting example of a game based on an ad pertaining to a particular good, service, or information; in this case, a game including a screen for redeeming a coupon awarded for game play.

FIG. 18 shows a non-limiting example of a game based on an ad pertaining to a particular good, service, or information; in this case, a view including a screen indicating that a coupon awarded for game play has been redeemed.

FIG. 19 shows non-limiting example of a game based on an ad pertaining to a particular good, service, or information; in this case, a game including a screen indicating that a user's accumulation of tokens awarded for game play has achieved a threshold level.

FIGS. 20-22 and 27 show non-limiting examples of implementations for the non-currency alternative to access goods, services, or information on the web described herein.

FIGS. 23-26 show a non-limiting exemplary process flow; in this case, a process for matching ads, ad-based games, and survey questions and for creating sequenced playlists of games tailored to particular users based on collected information such as user profile data.

FIG. 28 shows a non-limiting example of an introduction screen for games based on an ad pertaining to a particular good, service, or information; in this case, an introduction offering a reward (in the form of a limited subscription to a media streaming service) to a user for playing.

FIG. 29 shows a non-limiting view of the game of FIG. 28; in this case, a view of an instruction screen for a trivia game.

FIG. 30 shows a non-limiting view of the game of FIG. 28; in this case, a view of a screen displaying a video-based ad.

FIG. 31 shows a non-limiting view of the game of FIG. 28; in this case, a view of a screen displaying a first trivia question based on the content of a video-based ad as well as four answer options.

FIG. 32 shows a non-limiting view of the game of FIG. 28; in this case, a view of a screen displaying the correct answer option for a first trivia question.

FIG. 33 shows a non-limiting view of the game of FIG. 28; in this case, a view of a screen displaying a correct answer option for a first trivia question, as well as an incorrect option selected by the user.

FIG. 34 shows non-limiting views of the game of FIG. 28; in this case, a view of a screen congratulating a user for completing the trivia game and presenting an option to show appreciation for the video-based ad by pressing a “like” button.

FIG. 35 shows a non-limiting view of the game of FIG. 28; in this case, a view of a “like” button after being clicked by the user.

FIG. 36 shows a second non-limiting example of a game based on an ad pertaining to a particular good, service, or information; in this case, a game including an instruction screen for a video puzzle game.

FIG. 37 shows a non-limiting view of the game of FIG. 36; in this case, a view of pieces of the video puzzle wherein the pieces are depicted in partially connected and unconnected states based on what is currently playing in the video ad.

FIG. 38 shows a non-limiting example of a game based on an ad pertaining to a particular good, service, or information; in this case, a game including an instruction screen for a sorting game.

FIG. 39 shows a non-limiting view of the game of FIG. 38; in this case, a view of frames captured from the video-based ad, wherein the frames are depicted in partially sorted and unsorted states based on their order of appearance in the video-based ad.

FIG. 40 shows a non-limiting example of a game based on an ad pertaining to a particular good, service, or information; in this case, a game including a screen indicating that a user's accumulation of tokens awarded for game play has achieved a threshold level.

FIG. 41 shows a non-limiting example of a screen based on FIG. 40 after the user has returned to the website location of the media provider and the particular good, service, or information has been awarded.

FIG. 42 shows a non-limiting example of an introduction screen for games based on an ad pertaining to a particular good, service, or information as seen on a mobile device such as a smartphone or tablet; in this case, an introduction offering a reward (in the form of tokens) to a user for playing.

FIG. 43 shows a non-limiting example of a game based on an ad pertaining to a particular good, service, or information as seen on a mobile device such as a smartphone or tablet; in this case, a game including an instruction screen for a sorting game.

FIG. 44 shows a non-limiting view of the game of FIG. 43 as seen on a mobile device such as a smartphone or tablet; in this case, a view of a screen displaying a video-based ad.

FIG. 45 shows a non-limiting view of the game of FIG. 43 as seen on a mobile device such as a smartphone or tablet; in this case, a view of frames captured from the video-based ad, wherein the frames are depicted in unsorted and partially sorted states based on their order of appearance in the video-based ad.

FIG. 46 shows a non-limiting view of the game of FIG. 43 as seen on a mobile device such as a smartphone or tablet; in this case, a view of a screen congratulating a user for completing the sorting game and displaying the points they received for game play.

FIG. 47 shows a non-limiting view of an in-game survey question as seen on a mobile device such as a smartphone or tablet; in this case, a survey question to collect data from the user about purchasing behavior.

FIG. 48 shows a non-limiting example of a game based on an ad pertaining to a particular good, service, or information as seen on a mobile device such as a smartphone or tablet; in this case, a game including an instruction screen for a trivia game.

FIG. 49 shows a non-limiting view of the game of FIG. 48 as seen on a mobile device such as a smartphone or tablet; in this case, a view of a screen displaying a video-based ad.

FIG. 50 shows a non-limiting view of the game of FIG. 48 as seen on a mobile device such as a smartphone or tablet; in this case, a view of a screen displaying a first trivia question based on the content of a video-based ad as well as four answer options.

FIG. 51 shows a non-limiting view of the game of FIG. 48 as seen on a mobile device such as a smartphone or tablet; in this case, a view of a screen displaying a correct answer option for a first trivia question.

FIG. 52 shows a non-limiting view of the game of FIG. 48 as seen on a mobile device such as a smartphone or tablet; in this case, a view of a screen displaying a correct answer option for a first trivia question, as well as an incorrect option selected by the user.

FIG. 53 shows non-limiting views of the game of FIG. 48 as seen on a mobile device such as a smartphone or tablet; in this case, a view of a screen congratulating a user for completing the trivia game and displaying the points they received for game play.

FIG. 54 shows a non-limiting example of a game based on an ad pertaining to a particular good, service, or information as seen on a mobile device such as a smartphone or tablet; in this case, a game including a screen indicating that a user's accumulation of tokens awarded for game play has achieved a threshold level.

### DETAILED DESCRIPTION OF THE INVENTION

Described herein, in certain embodiments, are computer-implemented systems comprising: a digital processing device comprising an operating system configured to perform executable instructions and a memory device; a computer program including instructions executable by the digital processing device to create an application for providing a non-currency alternative to access goods, services, or information comprising: a software module configured to receive input from a user identifying a particular good, service, or information and indicating a request to access the particular good, service, or information via a non-currency alternative payment method; a software module configured to select a game from a database of games, the game based on an ad; a software module configured to present the game to the user and track the user's game play; and a software module configured to provide access to the good, service, or information in response to the user's game play achieving one or more completion criteria.

Also described herein, in certain embodiments, are non-transitory computer-readable storage media encoded with a computer program including instructions executable by a processor to create an application for providing a non-currency alternative to access goods, services, or information comprising: a software module configured to receive input from a user identifying a particular good, service, or information and indicating a request to access the particular good, service, or information via a non-currency alternative payment method; a software module configured to select a game from a database of games, the game based on an ad; a software module configured to present the game to the user and track the user's game play; and a software module configured to provide access to the good, service, or information in response to the user's game play achieving one or more completion criteria.

Also described herein, in certain embodiments, are computer-implemented methods for providing access to goods, services, or information via a non-currency alternative payment method comprising: receiving, by a computer, input from a user identifying a particular good, service, or information and indicating a request to access the particular good, service, or information via a non-currency alternative payment method; selecting, by the computer, a game from a database of games, the game based on an ad; presenting, by the computer, the game to the user and track the user's game play; and providing, by the computer, access to the good, service, or information in response to the user's game play achieving one or more completion criteria.

Also described herein, in certain embodiments, are non-transitory computer-readable storage media encoded with a computer program including instructions executable by a processor to create an application for providing a non-currency alternative to access goods, services, or information comprising: a software module configured to receive input from a user indicating a request to access a particular good, service, or information; a software module configured to select a game from a database of games, the game based on an ad; a software module configured to present the game to the user and track the user's game play; and a software module configured to provide access to the good, service, or information, the access provided when the user's game play achieves one or more completion criteria, by way of non-limiting example: reaching an “Unlock” point threshold, completing a minimum number of games, or being issued a random “instant win.”

Also described herein, in certain embodiments, are computer-implemented systems comprising: a digital processing device comprising an operating system configured to perform executable instructions and a memory device; a computer program including instructions executable by the digital processing device to create an application for providing a non-currency alternative to access goods, services, or information comprising: a software module configured to receive input from a user indicating a request to access a particular good, service, or information; a software module configured to select a game from a database of games, the game based on an ad; a software module configured to present the game to the user and track the user's game play; and a software module configured to provide access to the good, service, or information, the access provided when the user's game play achieves one or more completion criteria, by way of non-limiting example: reaching the “Unlock” point threshold, completing a minimum number of games, or being issued a random “instant win.”

Also described herein, in certain embodiments, are computer-implemented methods for providing access to goods, services, or information comprising the steps of: receiving, by a computer, a request from a user for access to a particular good, service, or information; selecting, by the computer, a game from a database of games, the game based on an ad; presenting, by the computer, the game to the user; tracking, by the computer, the user's game play; and providing, by the computer, access to the good, service, or information, the access provided when the user's game play achieves one or more completion criteria, by way of non-limiting example: reaching the “Unlock” point threshold, completing a minimum number of games, or being issued a random “instant win.”

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, the term “publisher” refers to creators, providers, and/or aggregators of content including, but not limited to, any party offering goods, services, and/or information online or through a brick and mortar outlet.

As used herein, the term “game” refers to any interactive, online experience.

As used herein, the term “ad” refers to any promotion of a product, service, or event.

### Overview

In some embodiments, described herein are platforms, systems, media, and methods for providing non-currency alternatives to access goods, services, and/or information through interaction with ad-based games. In further embodiments, a user accesses goods, services, and/or information by spending their time and attention interacting with the ad-based games. In still further embodiments, interaction with ad-based games serves as full payment or consideration for the goods, services, and/or information. In other embodiments, interaction with ad-based games serves as partial payment or price offset for the goods, services, and/or information.

The inventions described herein encompass computer-based platforms, computer-based systems, computer-readable media encoded with computer programs, and computer-implemented methods. In some embodiments, the platforms and systems are internet-based. In further embodiments, the platforms and systems are web-based. In still further embodiments, the platforms and systems are cloud computing-based. In some embodiments, the platforms and systems are utilized to offer software-as-a-service (SaaS). In some embodiments, the platforms and systems are utilized to offer services through mobile applications. In other embodiments, the platforms and systems are utilized to offer services through game consoles, set-top boxes, internet appliances, airplane seat-back screens, and/or vehicles. In some embodiments, an ad-based game experience is an opt-in experience. In further embodiments, an ad-based game experience is presented in a new browser window or a pop-up window overlaying information about the goods, services, and/or information.

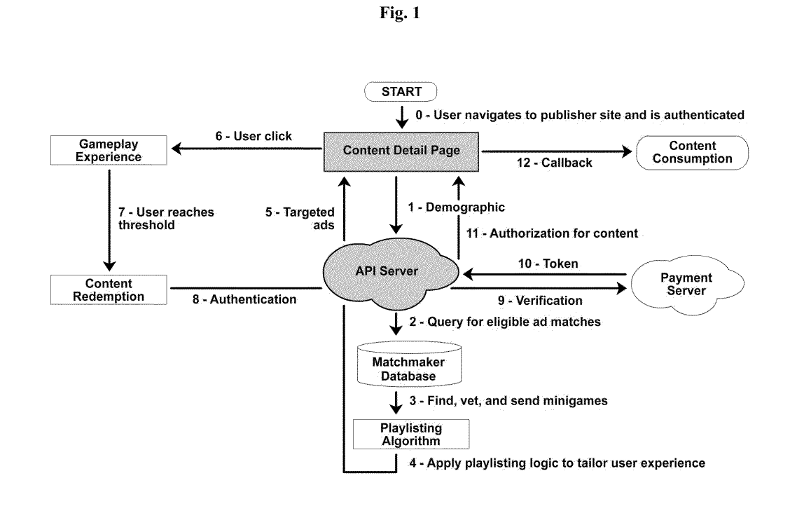

Referring to FIG. 1, in a particular embodiment, a user first navigates to a content publisher site 0 and the publisher authenticates the user (e.g., determines the user's identity). Any web site, mobile application, or standalone application offering content is suitable. In various embodiments, suitable content includes, by way of non-limiting examples, social networking, professional networking, games, news, articles, music, videos, blogs, messaging, interactive tools, and the like. On page load, user information 1 is sent to an API server. The API server then queries a matchmaker database 2 to determine if ads are available that are matched to the user's demographic or other data obtained about that user and the context of the offered content. Next, games based on appropriate ads are located and vetted 3. A playlisting algorithm applies playlisting logic to tailor the user experience 4 by selecting and ordering games based on the user's demographic and other information. Game play with targeted video ads is then sent client-side via the content publisher's web site or application 5. At this point the user optionally selects the “Unlock” button input 6 to access content of their choice, which launches the game play experience. When the user's game play fulfills one or more completion criteria including, by way of non-limiting example: reaching the “Unlock” point threshold, completing a minimum number of games, or being randomly rewarded with an “instant win,” 7 the selected content reaches a redemption point. The API server authenticates and verifies the unlock event 8 and the server passes verification 9 to a publisher partner payment server. Upon receipt of a verified unlock event, the publisher server sends a payload/token to the API server 10, authorizes the user is authorized for access to the content 11 and a callback fires 12 that allows the user to consume the content.

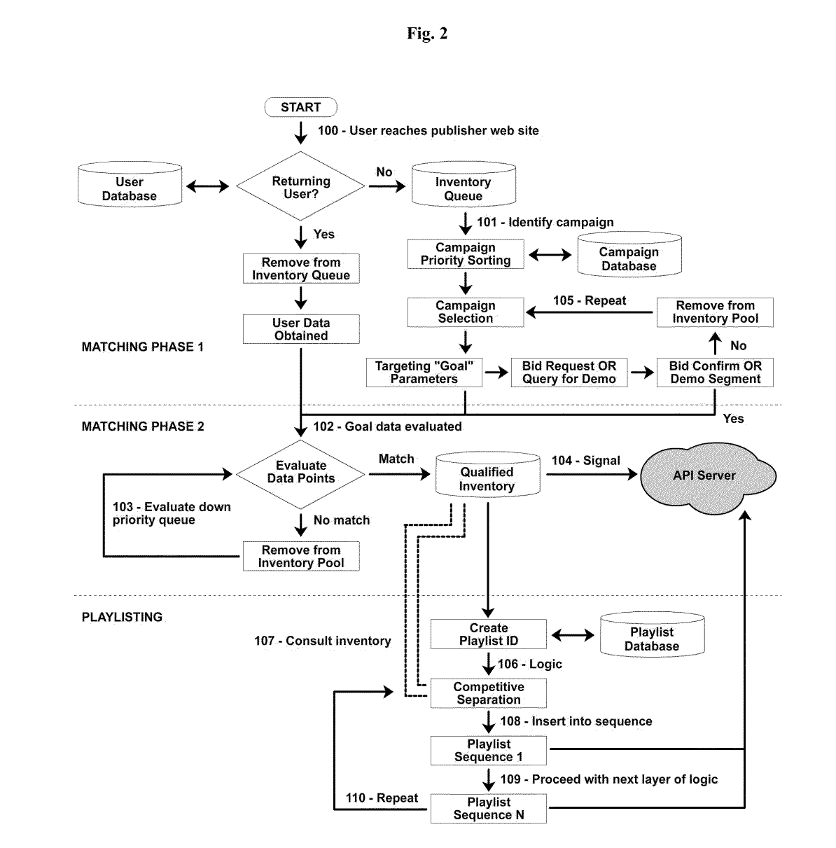

Referring to FIG. 2, in a particular embodiment, ad campaigns are selected for a particular user and game content is playlisted to create back-to-back game play experiences tailored to the information known about the user. This process starts when a user navigates to a publisher site and the workflow is initialized 100. In a first targeting matchmaker phase, user identity data (such as a cookie) is queried to determine if a user is a returning user or a new user and given the appropriate set of games. Eligible campaigns are filtered based on parameters, including priority, completed game permutations, irrelevant campaigns, active status and date ranges, within campaign spend limits and reached frequency caps. Subsequently, user data points are obtained and are populated into an “actual” data table. If the user is not a returning user (i.e., a new user), the targeting needs of the first campaign in the queue are checked. The inventory queue is filtered for campaigns by active status, active data range, and within campaign spend limits. Next, in this particular embodiment, the campaign priority is sorted to identify a first campaign 101.

Continuing to refer to FIG. 2, in a particular embodiment, the priority of each campaign is calculated based on its quota into three tiers: high, medium, and low. This happens at the campaign level, once or more per day. For example, Campaign X applies quota calculations to the nearest hundredth (percent): Step 1—number of days active/number of days flight for variable A; Step 2—current number of plays/target number of plays for variable B; Step 3—evaluate A to B; Step 4—if A>B assign to high priority, if A=B (or +/−10%) assigned to medium priority, if A<B assign to low priority. A campaign is selected first among high, then medium, then low priority campaigns. Targeting “goal” parameters for the campaign are passed to the “goal” data table. At this point either goal data is evaluated in a second targeting matchmaker phase, or a bid request with targeting segment (e.g., male, 18-24, etc.) is sent to a first publisher or a query for demo data is made to a second publisher. In response, the first publisher optionally returns a yes/no confirmation on the user segment or the second publisher provides a segment. If there is no match, the matchmaker removes all campaigns with the same targeting goal requirements from the inventory pool (e.g., remove all campaigns requiring male, 18-24, etc.), a new campaign is selected, and the process repeats. If there is a match, user data is passed to the “actual” data table.

Continuing to refer to FIG. 2, in a particular embodiment, a second targeting matchmaker phase includes evaluation of actual against goal data points down the priority queue 102. If all goal data are a match, the current campaign is moved to a qualified inventory pool of eligible campaigns for the user and an “inventory available” signal 104 is sent to the API server. If the goal data are not a match, the campaign and all associated game permutations are removed from the inventory pool and the evaluation of actual against goal data continues down the priority queue. Once qualified campaigns have been qualified for inventory that is eligible based on predetermined criteria, playlisting will determine the correct sequence in which to serve games to the user.

Continuing to refer to FIG. 2, in a particular embodiment, a playlisting phase starts with creation of a unique playlist ID. Next, in this embodiment, playlisting logic 106 is applied. A playlist queue is meant to be an ad-hoc, uniquely identified container that operates similarly to the inventory pool. It takes the qualified inventory and further processes it to determine the exact sequence of game permutations to serve as a playlist. Competitive separation involves consulting the qualified inventory for the highest priority campaign and subsequently removing all instances from the playlist with the same industry vertical data points. The selected game is inserted into a first playlist sequence 108. The playlisting process proceeds with the next layer of logic 109, applies a new round of competitive separation, inserts the next game into the sequence, and repeats 110 to create a playlist of any length, which is eventually sent to the API server.

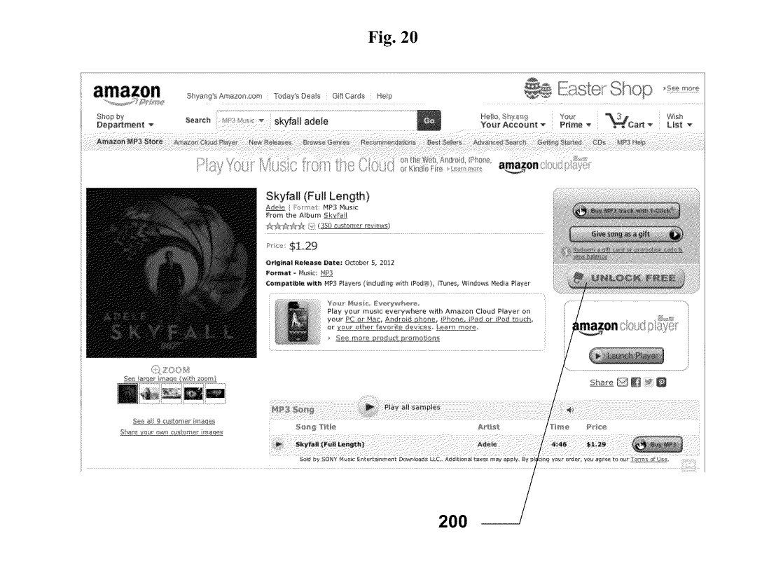

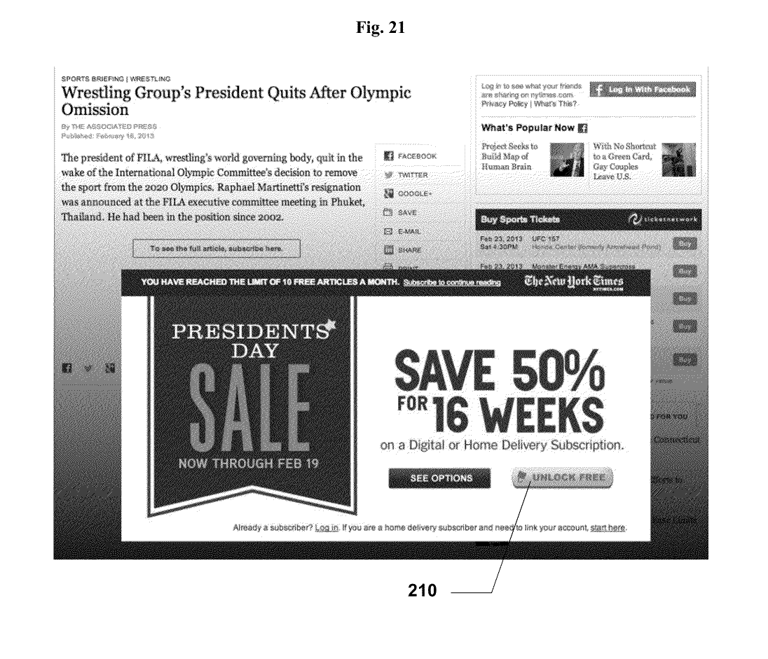

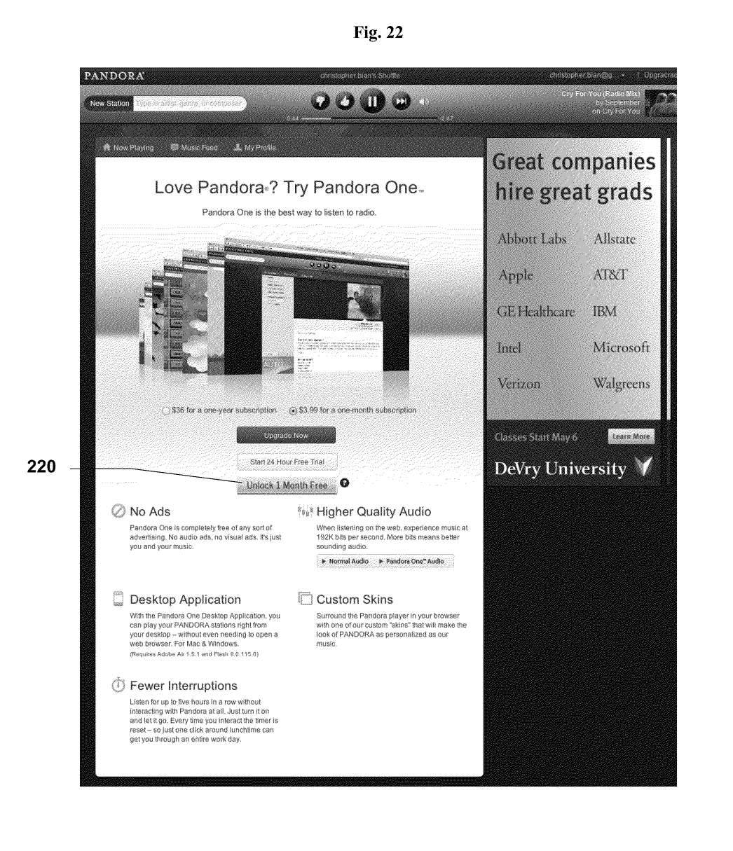

Referring to FIGS. 20-22, in particular embodiments, access to the non-currency alternatives to access goods, services, and/or information on the web described herein is presented to users as a button, link, or other input to begin the ad-based game experience. Many implementations are suitable including, by way of non-limiting examples, implementation on an e-commerce web site (see, e.g., FIG. 20, 200), as part of a pop-up offer on a web site (see, e.g., FIG. 21, 210), and as part of an in-app offer (see, e.g., FIG. 22, 220). In these particular embodiments, access to the inventions described herein is presented in conjunction with, and in proximity to, traditional means of access such as “Buy Now” or “Upgrade” buttons or links.

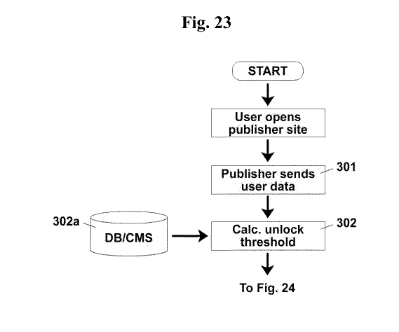

Referring to FIG. 23-26, in a particular embodiment, games based on a video ad are selected based on information known about the user and system rules that help to deliver a relevant, quality user experience. An exemplary high level process comprises a user clicking or tapping an unlock button, to initiate a non-currency, alternative method of accessing goods, services, or information. In response, a publisher creates a game session and sends user information to unlockable. The unlockable infrastructure gets an inventory pool, gets a playlist sequence, checks for eligible survey questions (also called “pathfinders”), and sends playlisted ad-based games to the client.

Referring to FIG. 23, in a particular embodiment, a user opens a publisher website or mobile application and sends Unlockable information such as but not limited to: user id, item id, and date of birth 301. Next, one of the completion criteria are set as the point threshold 302 which is calculated by the server based on 302a. In this embodiment, a database/content management system 302a retrieves reward value from a reward table, retrieves unlockable margin, retrieves campaign financial parameters (e.g., campaign CPE), and retrieves a normalized average score for a game. Based on these values, an unlock threshold is calculated, for example, as reward value/(1-margin) (campaign CPE)*normalized score.

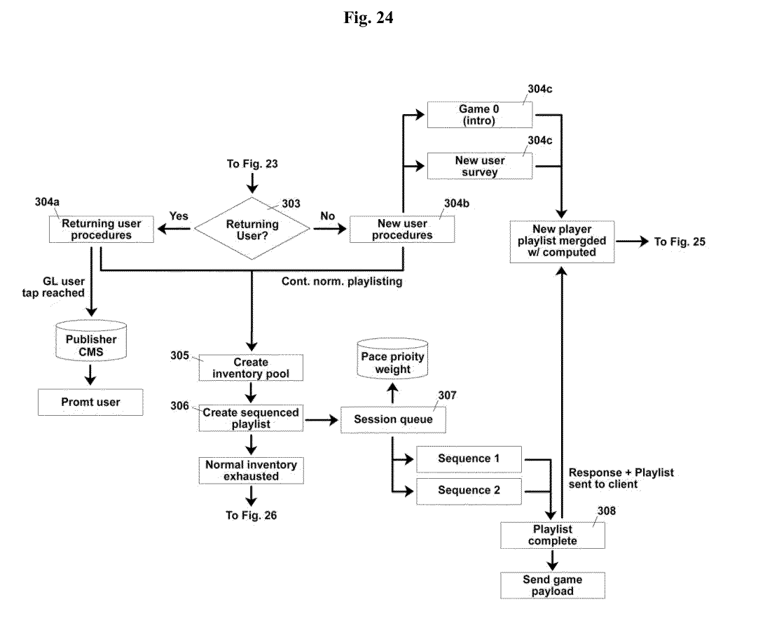

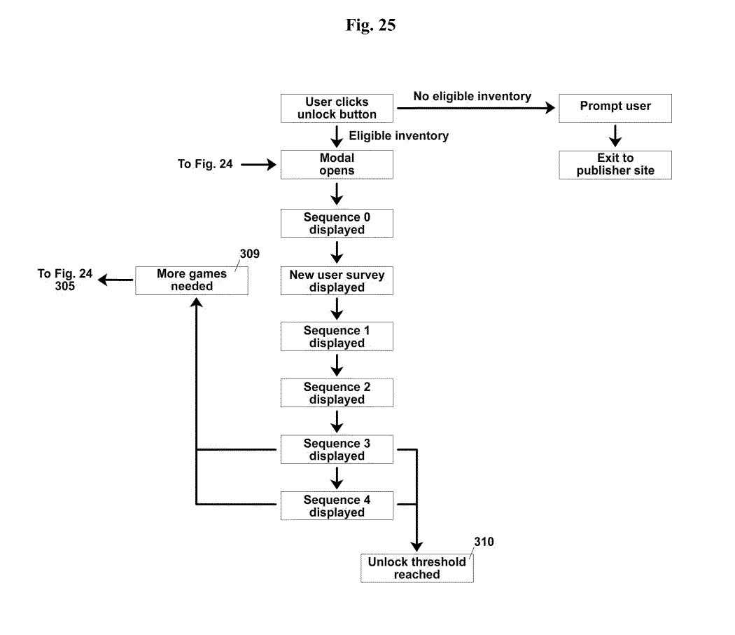

Referring to FIGS. 24 and 25, in a particular embodiment, a user is checked for whether the user is new or returning 303. Based on that result, the user will be given a returning user playlist 304a or a new user playlist 304b. In this example, a returning user playlist is determined, for example, by setting an unlock threshold, checking daily user limit, and retrieving data from the user's profile. If a daily limit is reached, the user is prompted to return at a later date. Further, in this example, a new user playlist is determined, for example, by setting an unlock threshold, queuing a game introduction, and serving a set of new user survey questions (e.g., pathfinders). A new user survey includes, for example, questions about gender, birth date, pets, hobbies, interests, and the like. Next, the system proceeds with normal playlisting by creating a pool of available inventory 305 under qualifying criteria, such as within a valid flight date range, under the quota of target engagements, and user matching the campaign target profile. The pool will then be sequenced into a playlist 306 by selecting by criteria such as the highest pace priority, game type, competitive separation, non-completed game id, and repeating game types. The playlist is then added to the user's session queue 307 where they have the opportunity to play the sequenced playlist. In this embodiment, each step in the sequence comprises, for example, a video, a game type, and an industry. Further in this embodiment, the session contains a sufficiently complete playlist 308 and is sent to the client with a response to the publisher that signals inventory is available. Optionally, the playlist and its associated data can be saved locally to the user's device for offline access. If the user satisfies one or more completion criteria 310, a postback is sent to the publisher to release the content, and the Unlockable modal closes. In the event that the playlist is not sufficient and more games are needed 309, the system will reengage the inventory pool and playlist sequencing process and repeat steps 305-308.

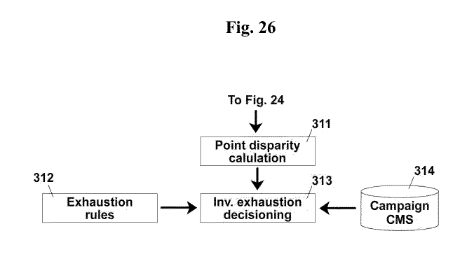

Referring to FIG. 26, in a particular embodiment, if no inventory is available, inventory exhaustion rules will be activated by calculating additional completion criteria needed 311, such as additional points required to reach the threshold. Inventory exhaustion rules 312 will apply to determine additional games to deliver to the user which are selectively activated by inventory exhaustion decisioning rules 313. Exhaustion rules are ranked from high to low priority and include but are not limited to: 1) allowing less strict targeting requirements, 2) serving additional survey question (e.g., pathfinders), 3) serving campaigns that are under 110% of the quota requirements, 4) serving remnant campaigns, 5) allowing re-selection of previously completed games farthest back in time, and if necessary, 6) defaulting to allow a user to Unlock the content. Data needed for the exhaustion rules to activate will be provided by calculations conducted on the server and the campaign CMS 314. In this embodiment, a campaign CMS comprises, for example, one or more target fields (e.g., age, gender, etc.) and for each target there is a corresponding exhaustion parameter that sets “softening” parameters, including a “strict” parameter meaning that the field cannot be opened. Softening parameters vary by target field type and include, for example, +/− numeric values for age, allocation across % ratio of gender, etc. In this embodiment, a campaign CMS further comprises, for example, query quotas by each target field so that performance in targeting delivery can be monitored, logs of actual flight start/end time stamps, sold though CPE value, and average score per ad.

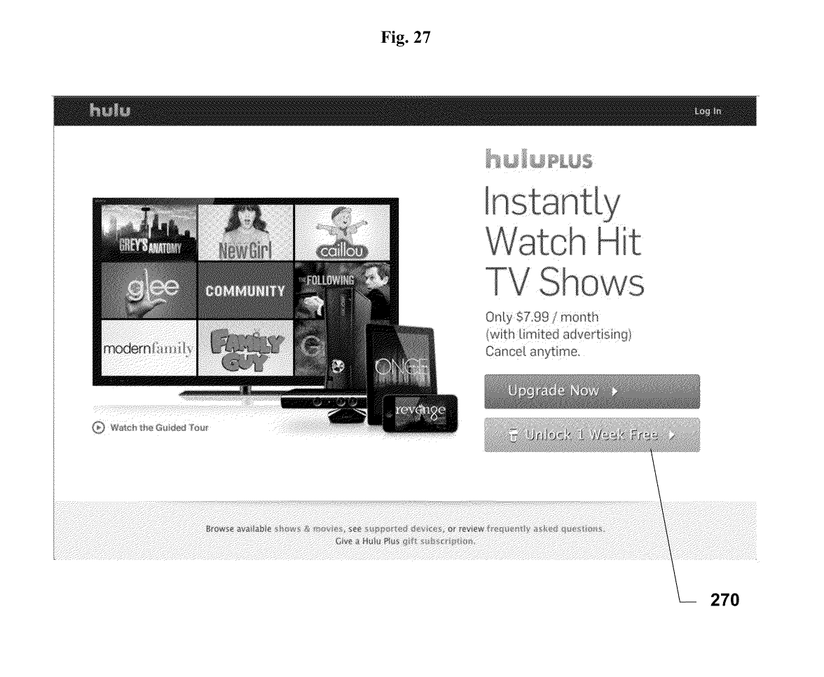

Referring to FIG. 27, in a particular embodiment, a non-limiting example of a media provider is shown, Hulu Plus. The “Unlock Button” 270 is placed underneath the payment option “Upgrade Now.” Selecting the Unlock 1 Week Free option will send a request to Unlockable servers for available ad-based games, wherein upon completion of game play based on one or more completion criteria, 1 free week of Hulu Plus media service is released to the user.

### Goods, Services, or Information

In some embodiments, the platforms, systems, media, and methods described herein include goods, services, and/or information, or use of the same. In further embodiments, the platforms, systems, media, and methods described herein provide users with a non-currency alternative to access goods, services, or information by spending their time and attention to interact with games based on ads. Any good, service, or information that can be purchased online or via mobile app using a currency-based transaction (including virtual currency) can also be unlocked and accessed via the non-currency techniques described herein.

Many goods are suitable. In some embodiments, suitable goods include digital goods that can be downloaded or otherwise accessed online or via mobile app. In various embodiments, suitable digital goods include, by way of non-limiting examples, albums, songs, movies, TV show episodes, TV show seasons, photos, videos, apps, games, and the like. In various embodiments, suitable digital goods include, by way of non-limiting examples, articles, e-books, and the like. In various embodiments, suitable digital goods include, by way of non-limiting examples, discounts, coupons, vouchers, and the like. In various embodiments, suitable digital goods include, by way of non-limiting examples, in-game purchases useful to a player in a game, virtual currency, and the like. In some embodiments, suitable goods include physical goods. In certain embodiments, suitable goods include those that can be shipped. In certain embodiments, suitable goods include low dollar value goods that can be earned by game play within a reasonable amount of time. Similarly, many services are suitable. In some embodiments, suitable services include subscription services. In various embodiments, suitable subscription services include, by way of non-limiting examples, magazine, mobile phone, cable TV, satellite TV, internet access, and similar services. Many types of information are also suitable. In various embodiments, suitable information includes, by way of non-limiting examples, articles, news, links, coupon codes, game codes, and the like.

In some embodiments, the platforms, systems, media, and methods described herein provide a non-currency alternative to access a particular, user-identified good, service, or piece of information. In further embodiments, the platforms, systems, media, and methods described herein provide a non-currency alternative to access a user-identified group or set of related goods, services, or pieces of information. In various embodiments, a group or set of related goods, services, or pieces of information includes, for example, about 2, 3, 4, 5, 6, 7, 8, 9, 10, 20, 30, 40, 50, 60, 70, 80, 90, 100, 150, 200, 250, 300, 350, 400, 450, 500 or more related goods, services, or pieces of information, including increments therein. In other embodiments, the platforms, systems, media, and methods described herein provide a non-currency alternative to access a plurality of user-identified goods, services, or pieces of information.

In some embodiments, a user identifies one or more goods, services, or pieces of information that they desire to access. Many user interactions made with a wide range of input devices are suitable to identify goods, services, and/or information. In some embodiments, a user identifies a desired good, service, or piece of information using a pointing device including, by way of non-limiting examples, a mouse, trackball, trackpad, gamepad, joystick, pen, or stylus. In further embodiments, a user identifies a desired good, service, or piece of information with a pointing device by actions including, by way of non-limiting examples, click, click and hold, double click, right click, shift-click, control-click, command-click, drag, draw, and highlight. In some embodiments, a user identifies a desired good, service, or piece of information using a touch screen display or multi-touch screen display. In further embodiments, a user identifies a desired good, service, or piece of information with a touch screen or multi-touch screen by gestures including, by way of non-limiting examples, tap (e.g., touch), double tap, tap (e.g., touch) and hold, swipe, drag, pinch, reverse pinch, draw, and highlight. In some embodiments, a user identifies a desired good, service, or piece of information using a keyboard, keypad, or alternative text input device, by keystroke, combination of keystrokes, or sequence of keystrokes. In other embodiments, a user identifies a desired good, service, or piece of information using a microphone to capture voice or other sound input. In other embodiments, a user identifies a desired good, service, or piece of information using a video camera to capture motion or visual input.

### Ads

In some embodiments, the platforms, systems, media, and methods described herein include ads, or use of the same. In further embodiments, the platforms, systems, media, and methods described herein display one ad. In other embodiments, the platforms, systems, media, and methods described herein display a group or set of related ads. In various embodiments, about 2, 3, 4, 5, 6, 7, 8, 9, 10, 20 or more ads are displayed, including increments therein. In further embodiments, the platforms, systems, media, and methods described herein present one or more games based on each ad.

Many types of ads are suitable. In various embodiments, suitable ads include, by way of non-limiting examples, text ads (e.g., headlines, blurbs, articles, etc.), static image (e.g., photograph, illustration, drawing, etc.) ads, animated image ads, audio ads, musical ads, video ads, multimedia ads, rich media ads, interactive ads, game-like ads, branded or unbranded content sponsored by an advertiser, and the like. Suitable ads have a wide range of durations. In various embodiments, a suitable ad has a duration of about 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200 or more seconds, including increments therein. In various further embodiments, a suitable ad has a duration of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more minutes, including increments therein. In a particular embodiment, the platforms, systems, media, and methods described herein allow repurposing of ads made for television, radio, game, or online interstitial or pre-roll uses.

The ads described herein suitably have a wide range of content/subject matter. In some embodiments, the subject matter of an ad includes content pertaining to one or more goods, services, or pieces of information identified by the user. In some embodiments, the subject matter of an ad includes content pertaining to one or more one or more goods, services, or pieces of information related to the goods, services, or pieces of information identified by the user. In other embodiments, the subject matter of an ad includes content not pertaining to the goods, services, or pieces of information identified by the user. In further embodiments, the subject matter of an ad includes content pertaining to the goods, services, or pieces of information identified based on user demographic information, user behavioral information, or other information described below.

In some embodiments, the content/subject matter of an ad described herein is selected based at least in part on pretext/referral data. In further embodiments, pretext/referral data include where the user came from and how they arrived at the location where they requested access to the good, service, or information. Non-limiting examples of referrers include a search engine, a referring website, a smartphone app, etc.

In some embodiments, the content/subject matter of an ad described herein is selected based at least in part on the specific content the user is requesting to unlock (i.e., gain access). In further embodiments, non-limiting examples of requested content include a movie, a song or album, news, a magazine, and the like.

In some embodiments, the content/subject matter of an ad described herein is selected based at least in part on context data. In further embodiments, a non-limiting example of context data includes the mindset of the user. By way of example, are they accessing a news website, meaning they are focused on getting to their destination? By way of further example, are they on a movie streaming site, meaning they are likely to be in a leisurely mindset?

In some embodiments, the content/subject matter of an ad described herein is selected based at least in part on information in the requesting user's profile. In further embodiments, non-limiting examples of user profile data include name, age, gender, geographic region, interests, buying habits, and the like.

In some embodiments, the content/subject matter of an ad described herein is selected based at least in part on survey data. In further embodiments, non-limiting examples of survey data include questions that a provider of the services described herein will ask of its users, e.g., “Do you own a pet?” or “Do you enjoy watching sports?” or “Will you be buying a new smartphone soon?”

In some embodiments, the content/subject matter of an ad described herein is selected based at least in part on third party integration. In further embodiments, the content/subject matter of an ad described herein is selected based at least in part on social networking data. In still further embodiments, non-limiting examples of social networking data include data integrated from Facebook, Twitter, LinkedIn, and the like.

In some embodiments, the content/subject matter of an ad described herein is selected based at least in part on user services. In further embodiments, non-limiting examples of user services include Gmail, Netflix, Pandora, Amazon, and the like.

In some embodiments, the content/subject matter of an ad described herein is selected based at least in part on external datasets. In further embodiments, non-limiting examples of external data sets include those from companies that collect a specific type of data, such as loyalty shopper programs, vehicle sales, and the like.

In some embodiments, the content/subject matter of an ad described herein is selected based at least in part on campaign and ad creative data such as the kinds campaigns/creatives the users have recently been exposed to, the nature of the campaigns (e.g., funny, informative, etc.), and the nature of the advertised goods.

In some embodiments, the content/subject matter of an ad described herein is selected based at least in part on game behavior data. In further embodiments, non-limiting examples of game behavior data include scores achieved by the user, time spent playing the games, whether the user is a new or a returning player, and prior exit points (e.g., at what point the user, or users in general, leave the experience).

In some embodiments, the content/subject matter of an ad described herein is selected based at least in part on conversion data. In further embodiments, non-limiting examples of conversion data include the branded offers seen, clicked, and redeemed and ratios thereof.

### Games

In some embodiments, the platforms, systems, media, and methods described herein include games, or use of the same. In further embodiments, the games are based on the subject matter of the ads described further herein. In still further embodiments, the goals of a game include user demonstration of retention of the subject matter of the ad. In still further embodiments, the goals of a game include user demonstration of understanding of the subject matter of the ad.

Games are produced by a variety of suitable methods. For example, in some embodiments, the platforms, systems, media, and methods described herein include a software module configured to create a game by applying a game template to ad media. In further embodiments, the game creation process is entirely automated. In other embodiments, the game creation process is partially automated. In some embodiments, the game creation process requires some degree of manual content management.

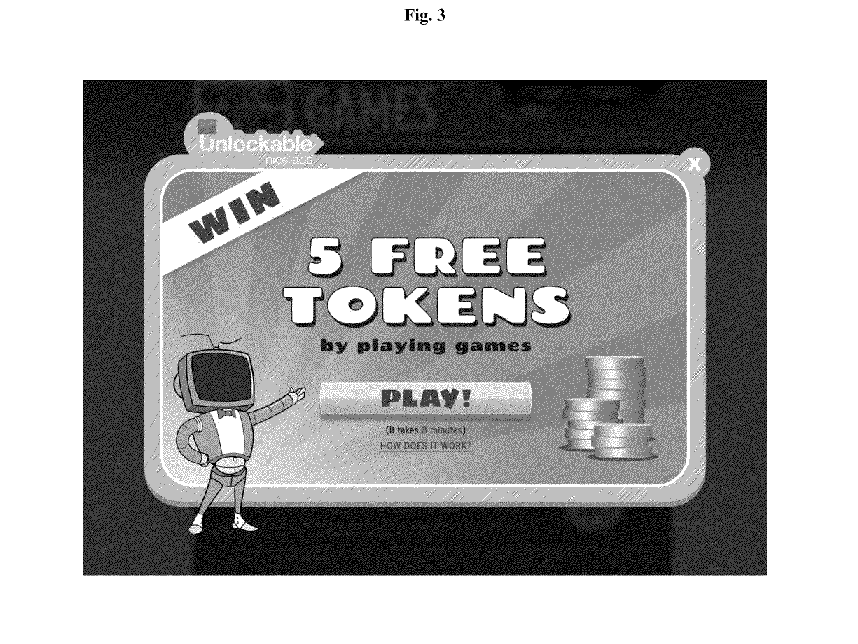

A wide variety of game formats and/or game templates are suitable for creation of a game based on an ad. In many suitable game formats, a user is asked to recognize and acknowledge aspects of the content of the ad while they are observing the ad or immediately before or after observing the ad for the first time or subsequent times. In some embodiments, a game comprises trivia from the ad. For example, in further embodiments, trivia questions ask about events, people, dialogue, or products depicted in an ad. See, e.g., FIGS. 3-8. In some embodiments, a game comprises objects the user is instructed to click or touch as they appear during playback of an ad video. For example, in further embodiments, a game includes a library of people, products, words, or sounds that must be recognized and identified while a user is watching a video ad. In some embodiments, a game comprises identifying a brand during playback of an ad video. In some embodiments, a game comprises a series of ad video segments that the user must identify by brand or product. In some embodiments, a game comprises syncing clicks or touches with specified time points during playback of an ad video. In some embodiments, a game comprises clicking or touching the differences between two similar ad images. In some embodiments, a game comprises clicking or touching hidden objects in an ad image. In some embodiments, a game comprises controlling a character within a 2-D or 3-D environment.

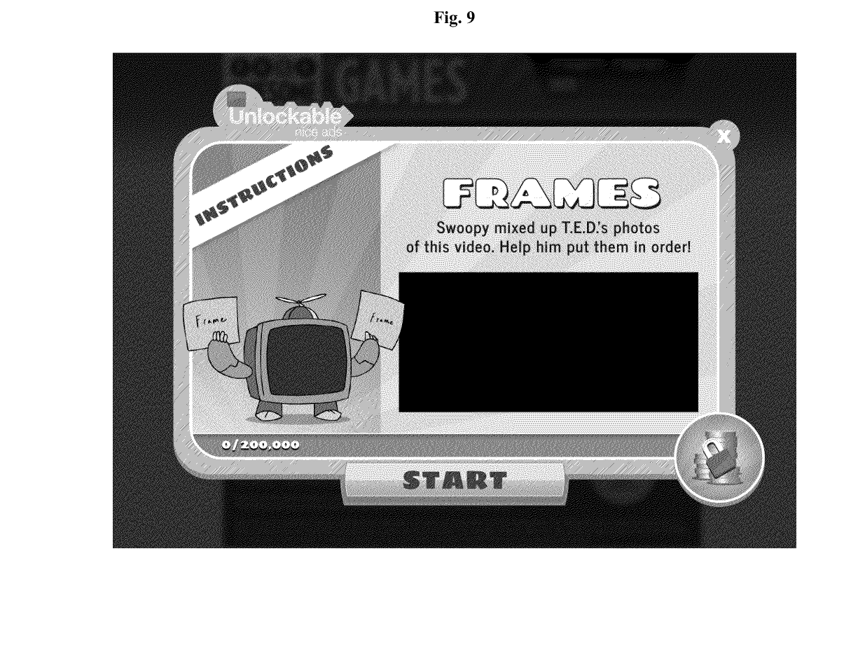

In many suitable game formats, a user is asked to recognize and acknowledge the order in which aspects of the content of the ad are depicted. In some embodiments, a game comprises sequencing images captured from the ad. For example, in further embodiments, a game includes ordering a plurality of frames captured from a video ad to match the order in which the frames appeared in the intact video ad. See, e.g., FIGS. 9-13. In some embodiments, a game comprises breaking a video into segments that the user reassembles during playback of an ad video. In some embodiments, a game comprises segments of an ad video falling from the top of the screen to a container, wherein the user clicks or touches the screen to guide the segments into the correct order. In some embodiments, a game comprises matching audio segments to the proper silent ad video segment. In some embodiments, a game comprises identifying an ad video from its audio track.

Referring to FIG. 3, in a particular embodiment, an ad-based game described herein is presented on a web site, mobile web site, or smartphone application offering online content for sale. A user clicks an “unlock” button, link, or other input that is presented adjacent, and as an alternative to a “buy” button associated with particular content, or in lieu of a “buy” button associated with particular content. By so doing, the user indicates that they would like to access the online content. In this embodiment, the game includes a screen advising the user of the value (e.g., tokens representing game play) that they can potentially earn by interacting with the game.

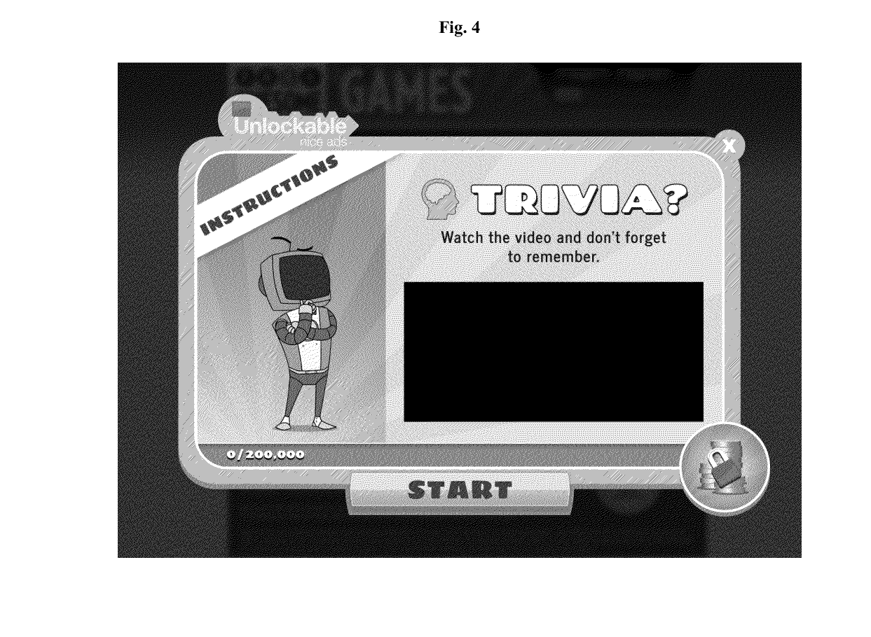

Referring to FIG. 4, in a particular embodiment, an ad-based game described herein is a trivia game, wherein text-based questions are presented to test the user's attention to, and understanding of, the content and subject matter of a video ad. In this embodiment, the game includes an instruction screen to advise the user how to play the game.

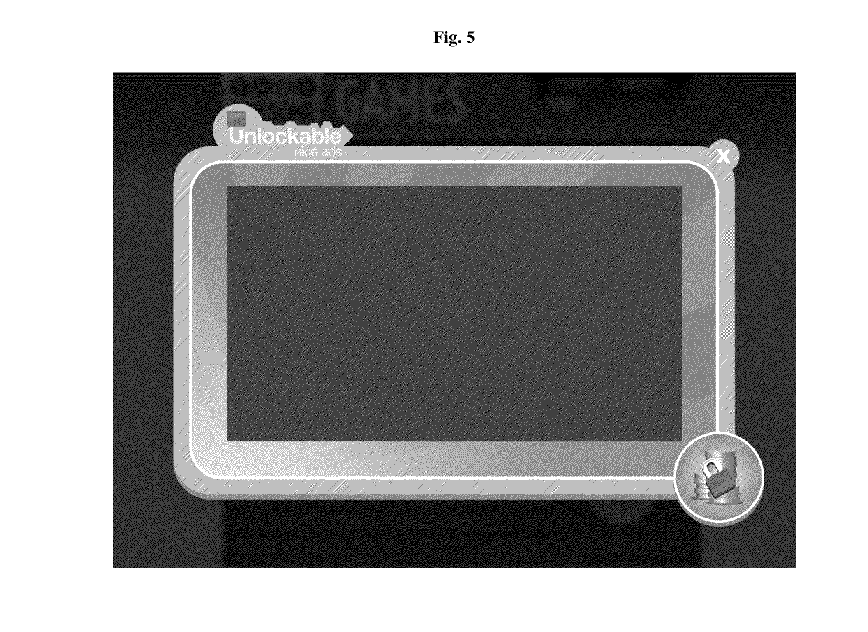

Referring to FIG. 5, in a particular embodiment, an ad-based game described herein presents a screen displaying a video ad for the user to observe. The ad is selected based on a number of factors including, by way of example, the user's demographic information, the user's historic behavior (e.g., previous game play, browsing history, etc.), and the good, service, or information that the user would like to access.

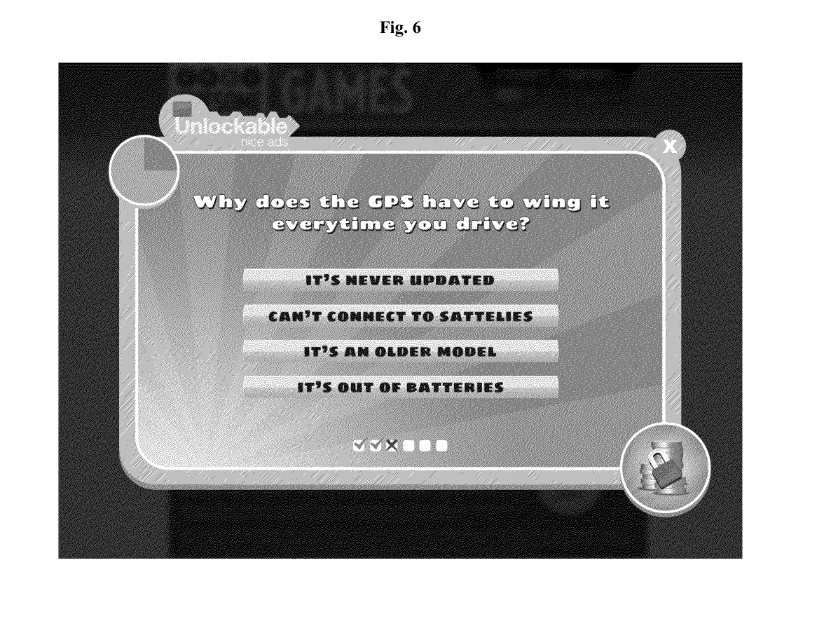

Referring to FIG. 6, in a particular embodiment, an ad-based game described herein is a trivia game that presents trivia questions after a video ad has been viewed by a user. In this embodiment, the trivia questions test the user's comprehension and attention to the video ad via multiple choice questions. In some cases, questions are presented at various time points during the video ad.

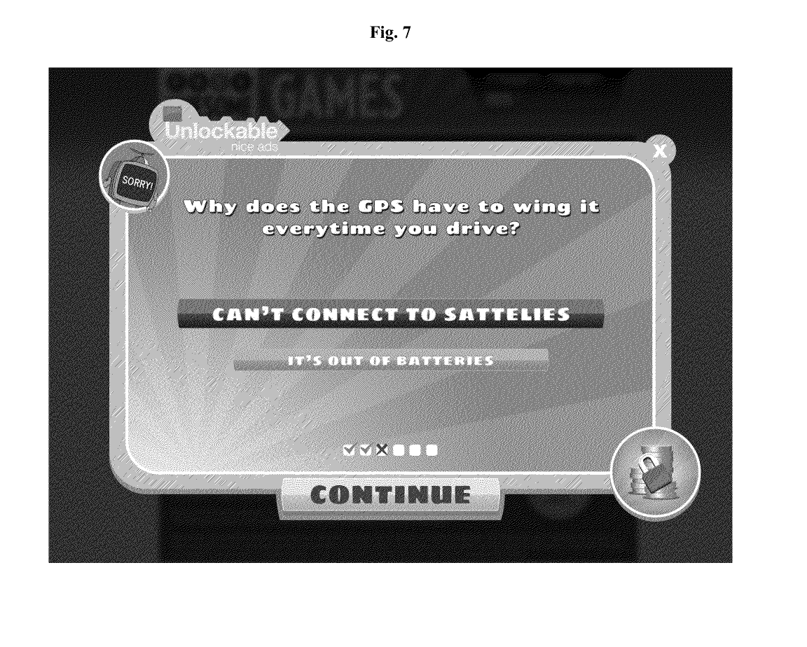

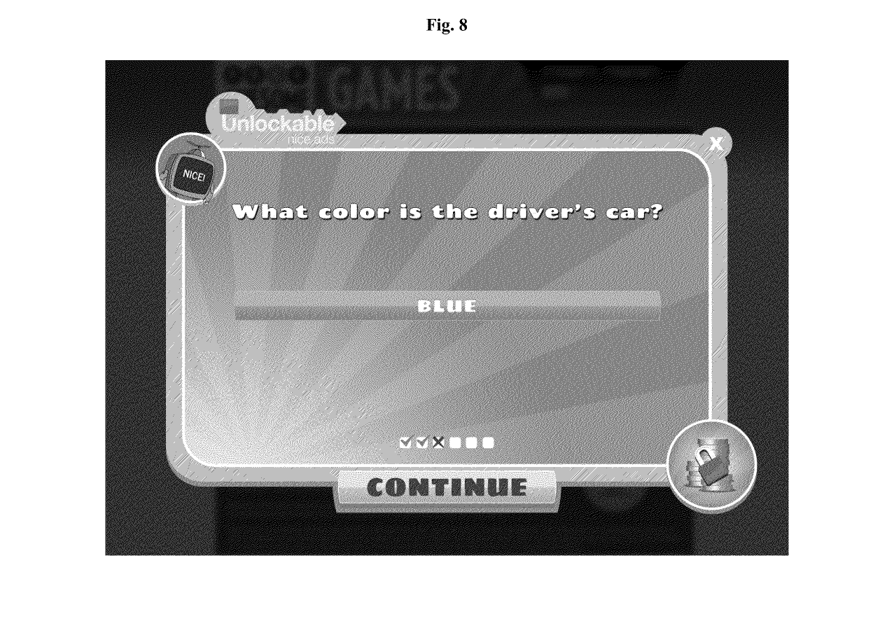

Referring to FIGS. 7 and 8, in particular embodiments, an ad-based game described herein is a trivia game that tracks user responses to the trivia questions and the user's performance in the game.

Referring to FIG. 9, in a particular embodiment, an ad-based game described herein is a sorting game, wherein still frames captured from a video ad are presented, which users are asked to sequence based on the order each appeared in the video ad. In this embodiment, sorting the frames tests the user's attention to, and understanding of, the content and subject matter of a video ad. In this embodiment, the game includes an instruction screen to advise the user how to play the game.

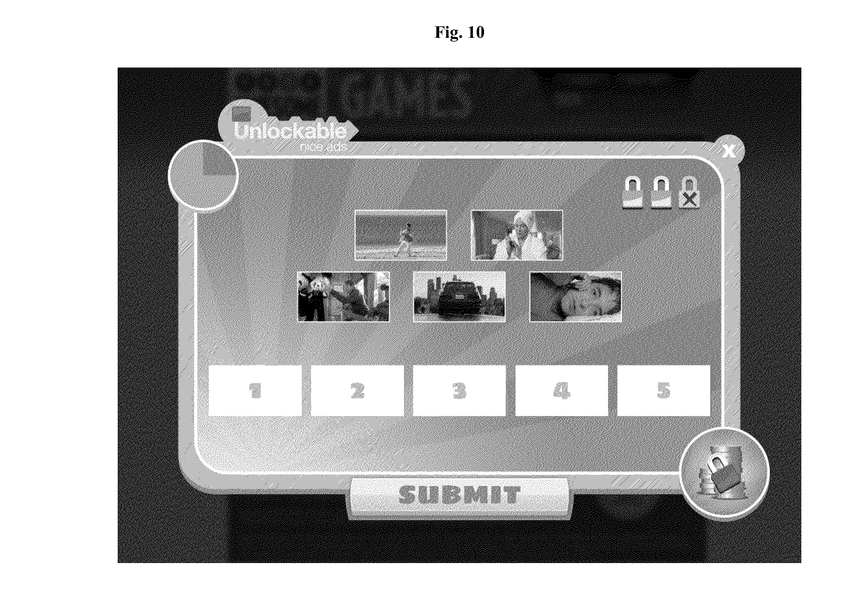

Referring to FIG. 10, in a particular embodiment, an ad-based game described herein is a video frame sorting game presenting several video frames to be sorted based on the order each appeared in a video ad.

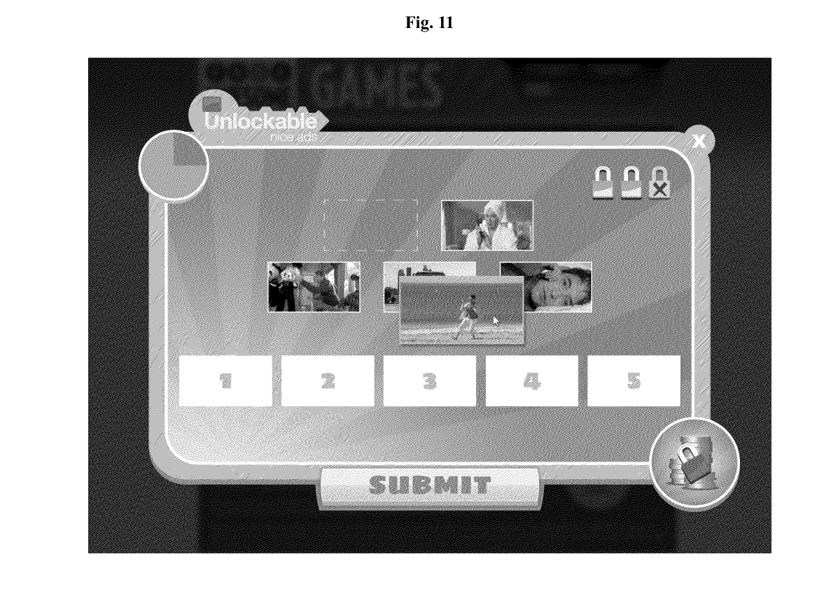

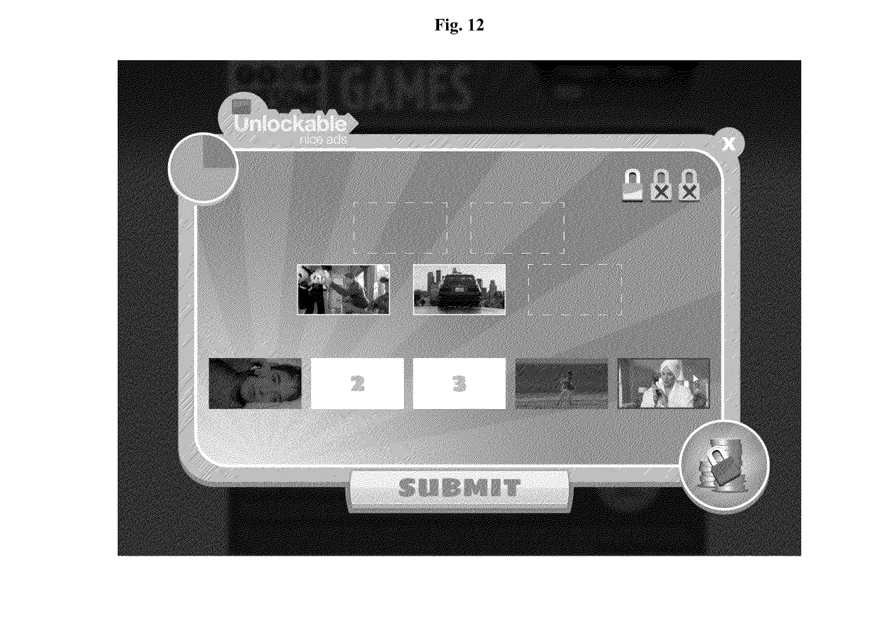

Referring to FIGS. 11 and 12, in particular embodiments, an ad-based game described herein is a video frame sorting game presenting several video frames to be sorted based on the order each appeared in a video ad. In these embodiments, the presented frames are partially sorted.

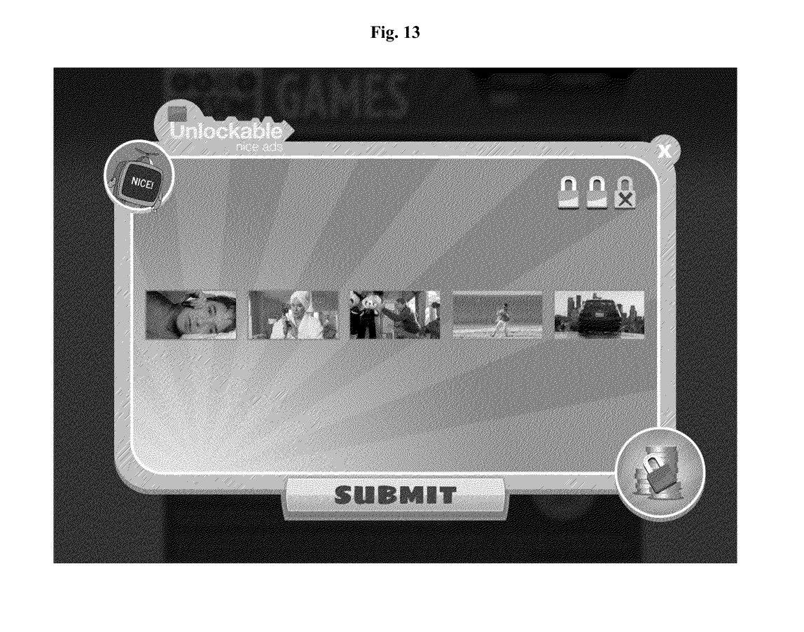

Referring to FIG. 13, in a particular embodiment, an ad-based game described herein is a video frame sorting game presenting several video frames to be sorted based on the order each appeared in a video ad. In this embodiment, the presented frames are completely sorted.

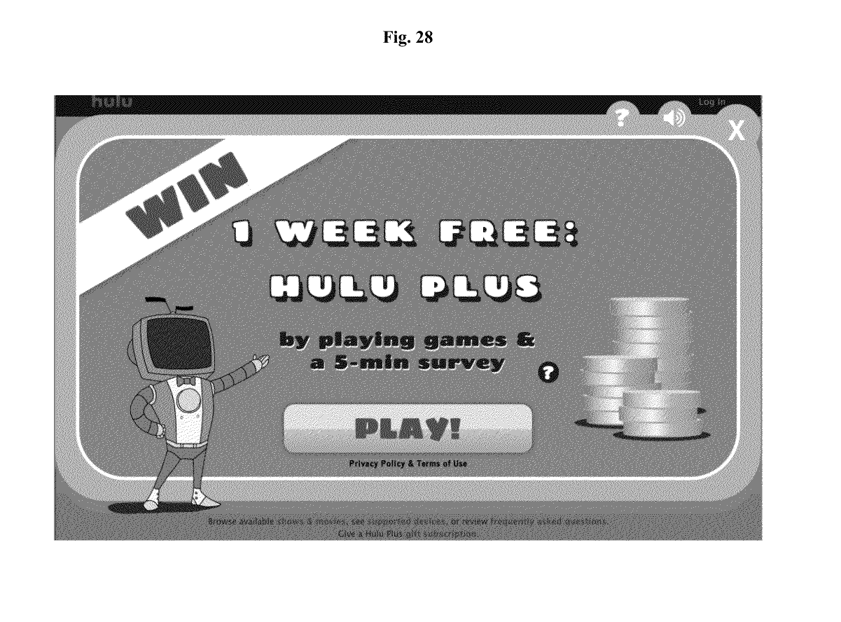

Referring to FIG. 28 in a particular embodiment, the Unlockable application opens within the context of the media provider property, website or application. The user is clearly told the content award, in this case 1 week of Hulu Plus. Buttons to access the FAQ, legal terms and privacy are given, in addition to buttons to adjust volume or get help.

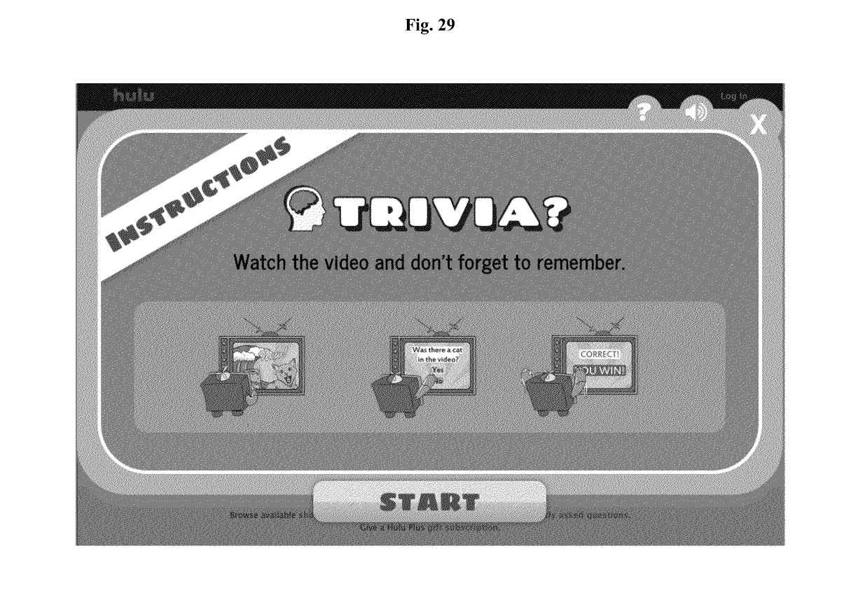

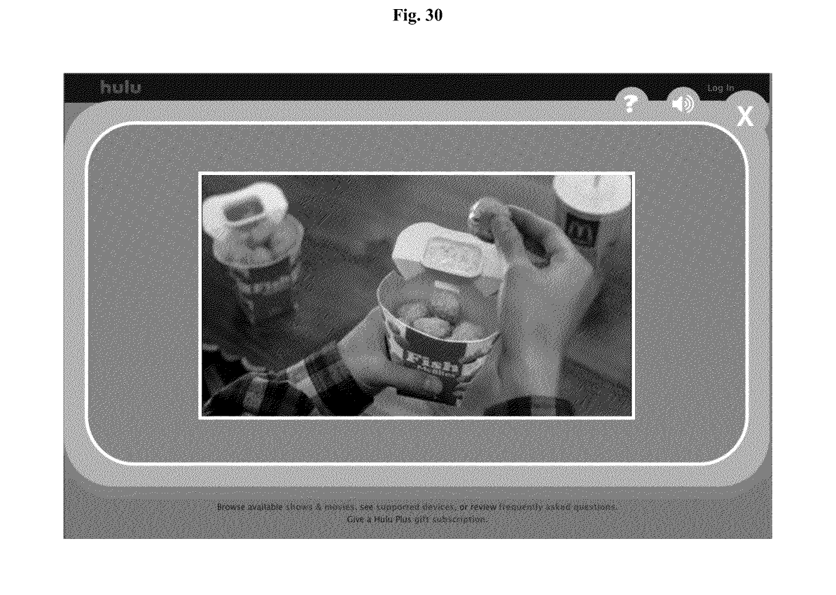

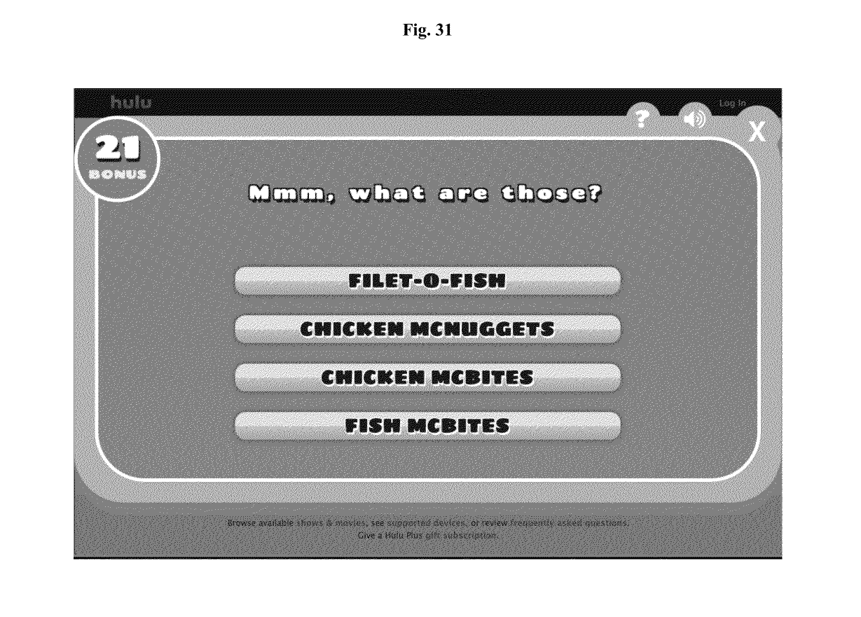

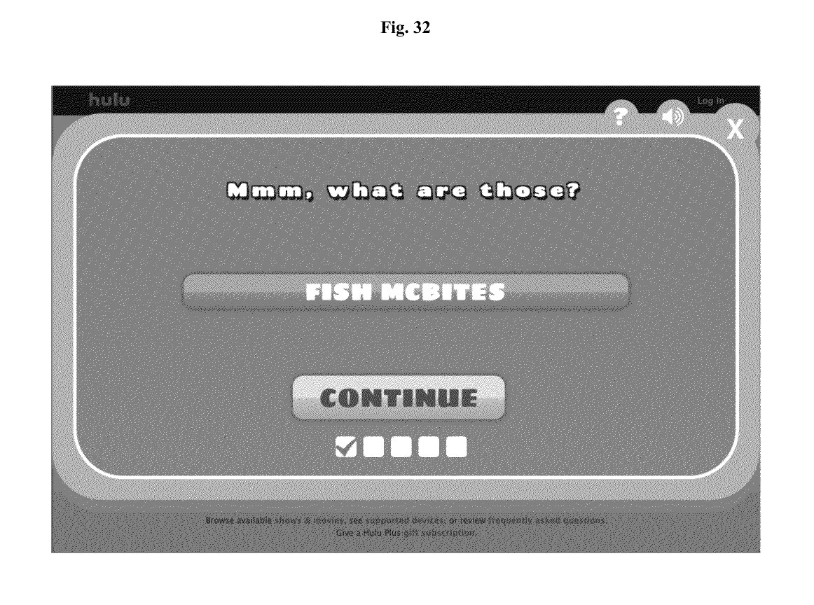

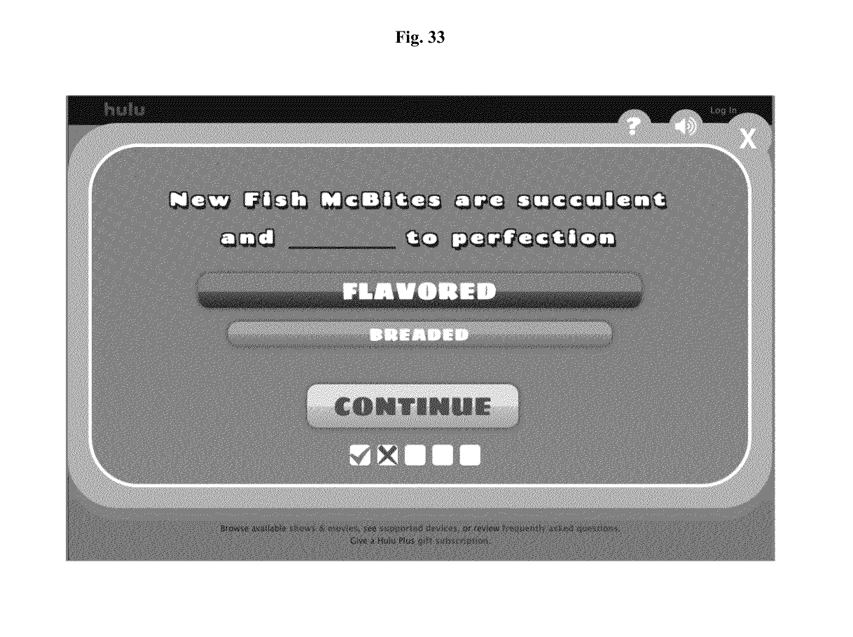

Referring to FIGS. 29-35 in a particular embodiment, an ad-based game is based on trivia questions. The user will first see instructions on how to play (see, e.g., FIG. 29), then proceed to watch the video ad (see, e.g., FIG. 32) selected to accompany this particular game. The user is then prompted to answer a number of trivia questions about the video ad, with a number of answer options, either multiple choice or open-ended (see, e.g., FIGS. 31-33).

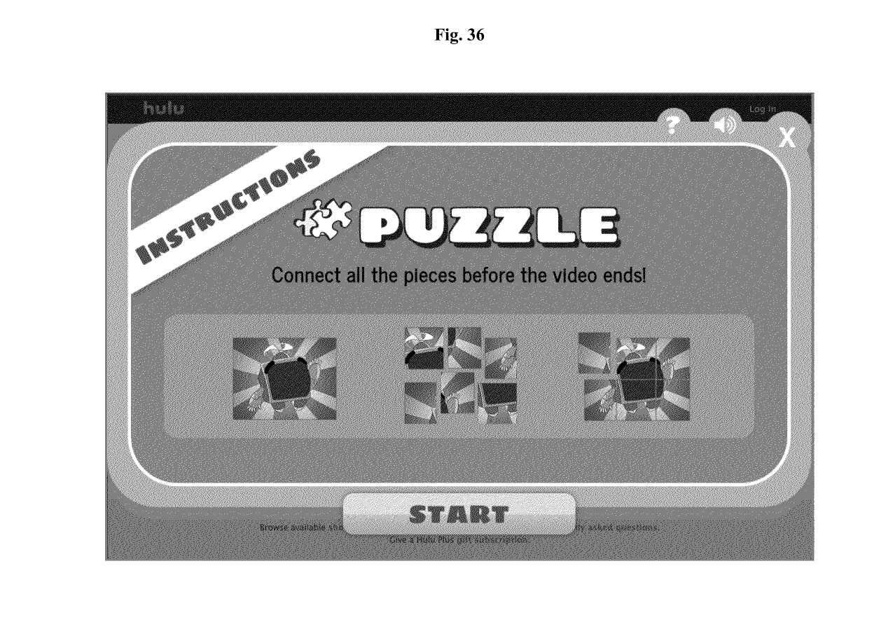

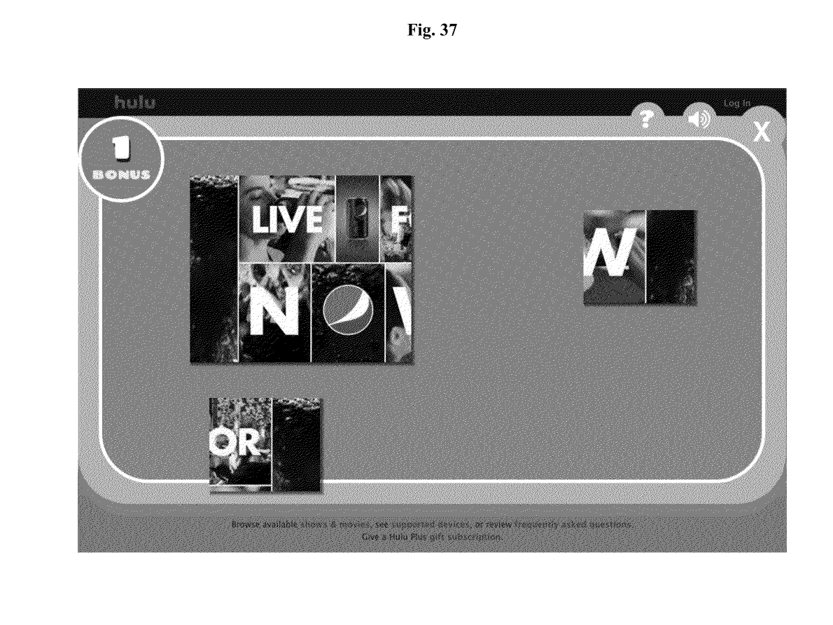

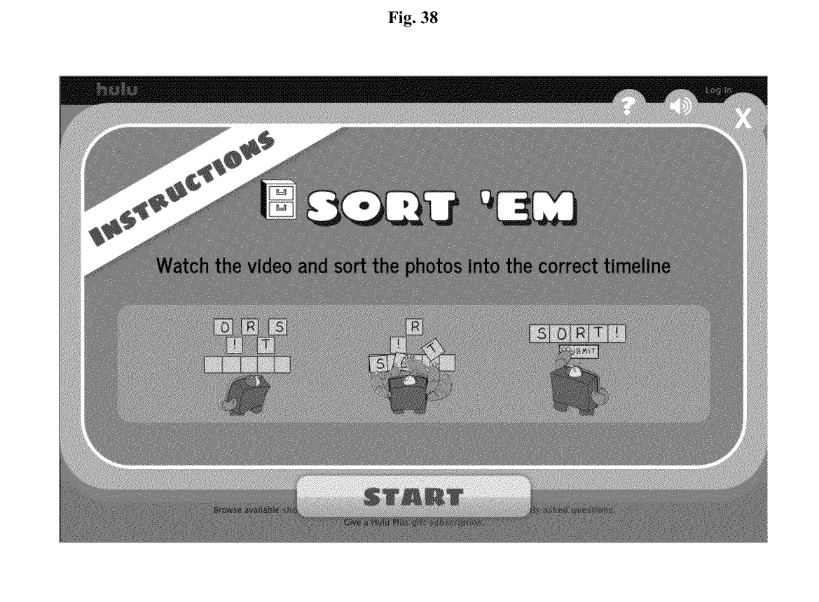

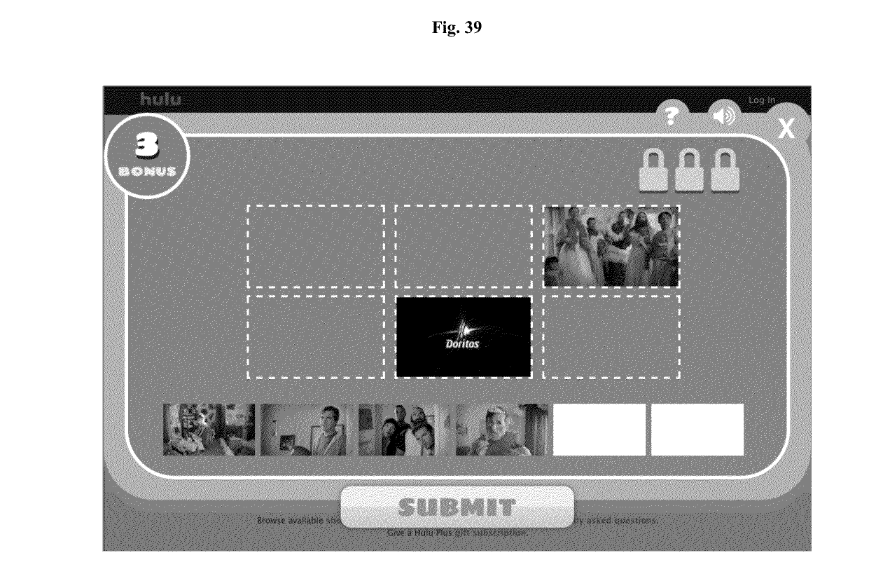

Referring to FIGS. 36-37, in a particular embodiment, an ad-based game is a video puzzle game. The user is again presented with instructions on how to play. See, e.g., FIG. 38. The user is asked to reconnect pieces of a video (see, e.g., FIG. 39) while each piece continues to play its respective portion of the video ad, including audio.

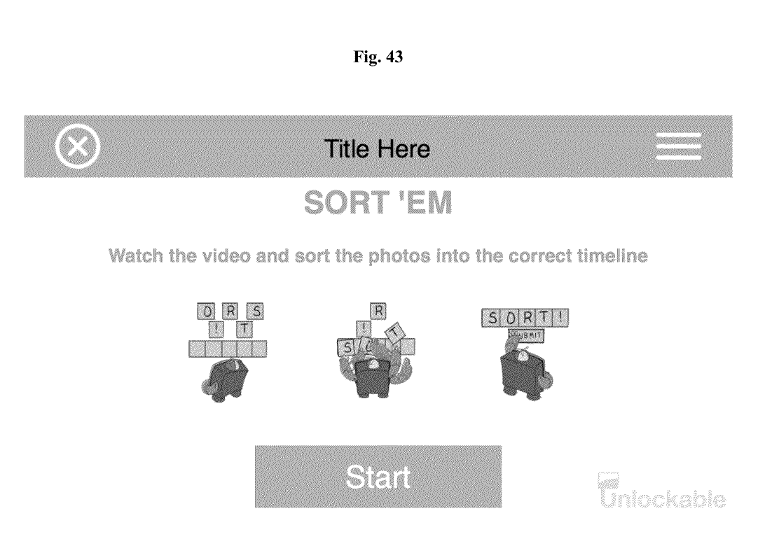

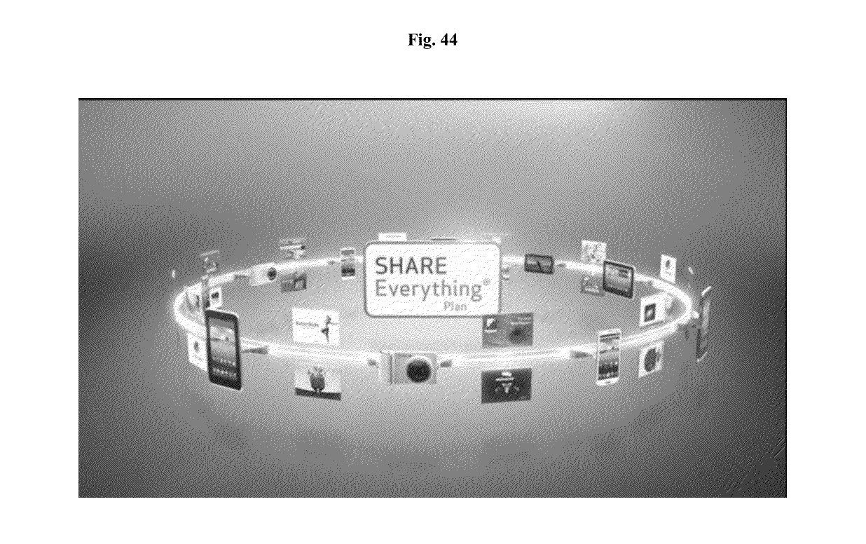

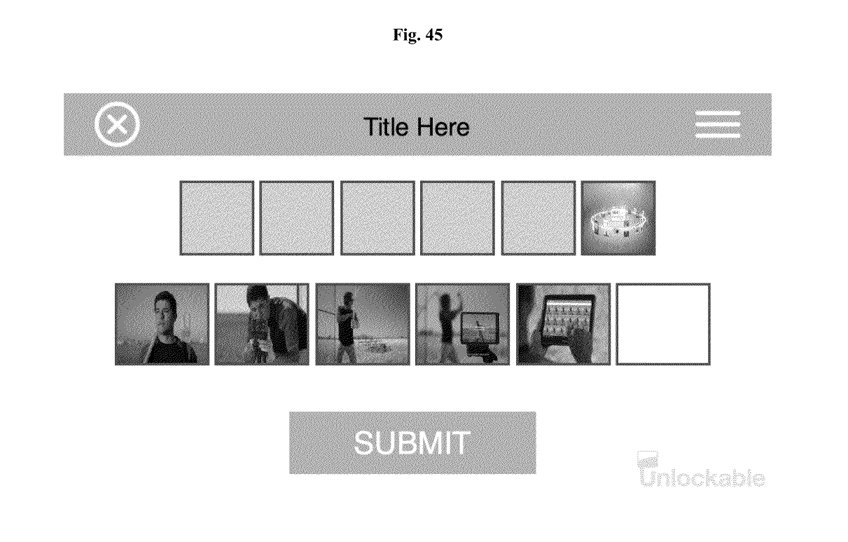

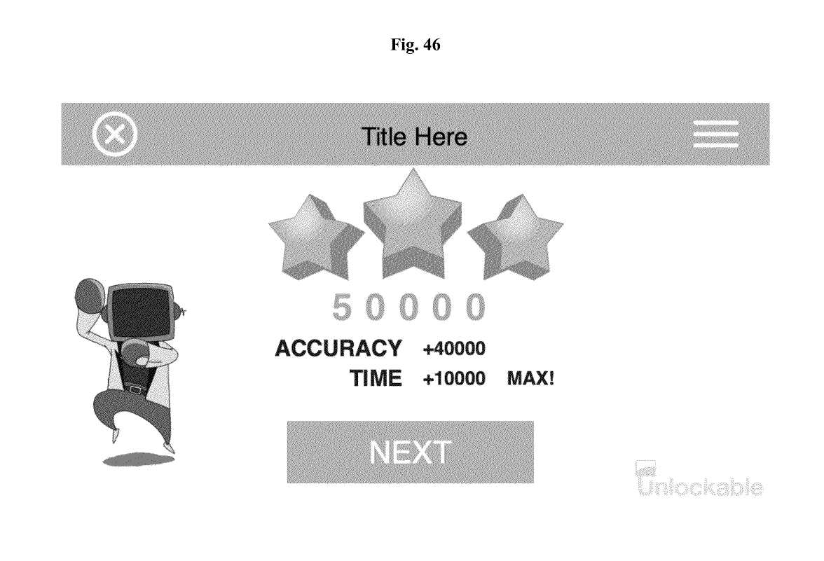

Referring to FIGS. 38-39 and 43-46 in a particular embodiment, an ad-based game is a sorting game. The user is again presented with instructions on how to play. See, e.g., FIGS. 38 and 43. The user is asked to sort any number of images from the video ad back into chronological order. See, e.g., FIGS. 39 and 45.

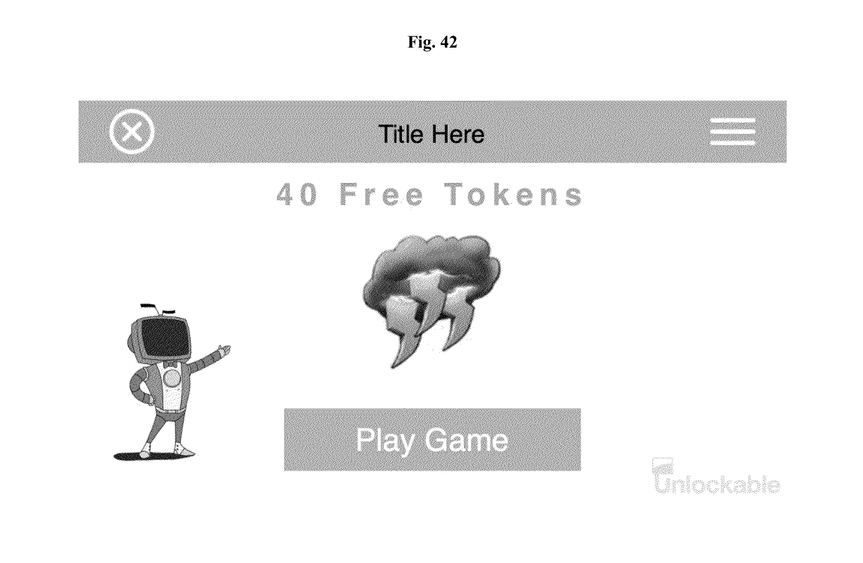

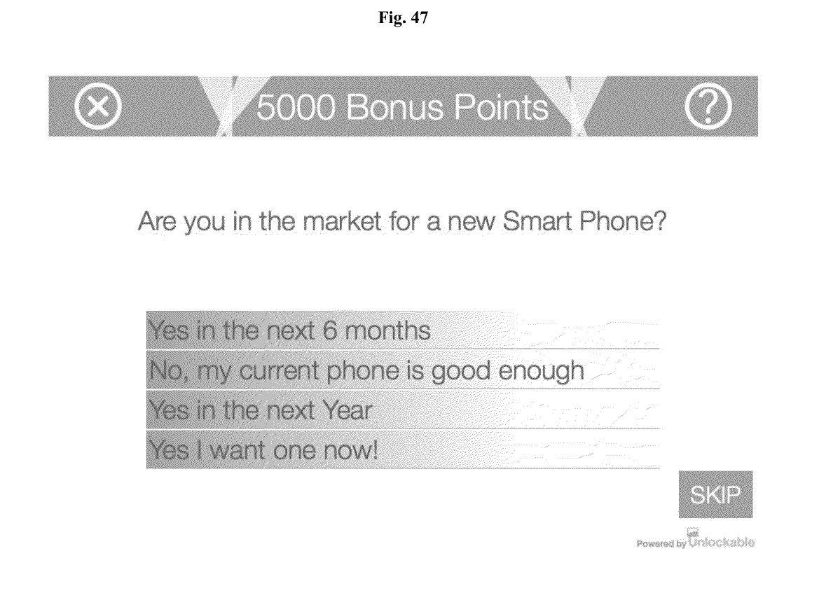

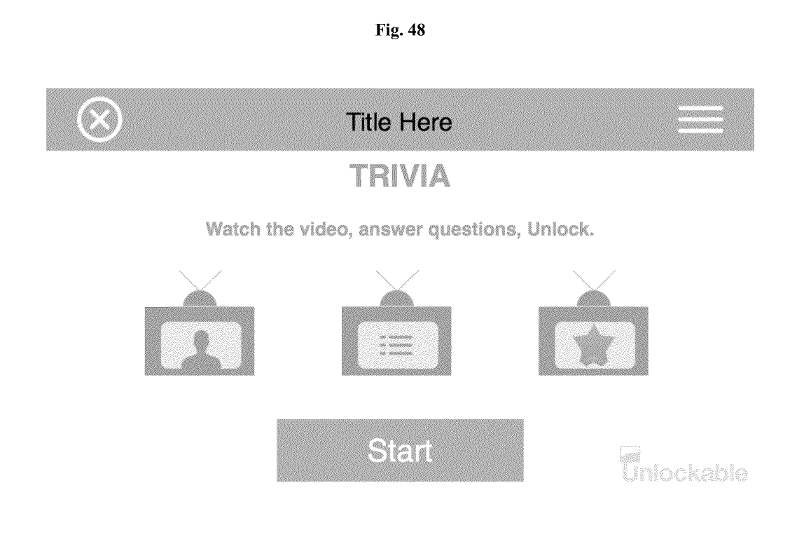

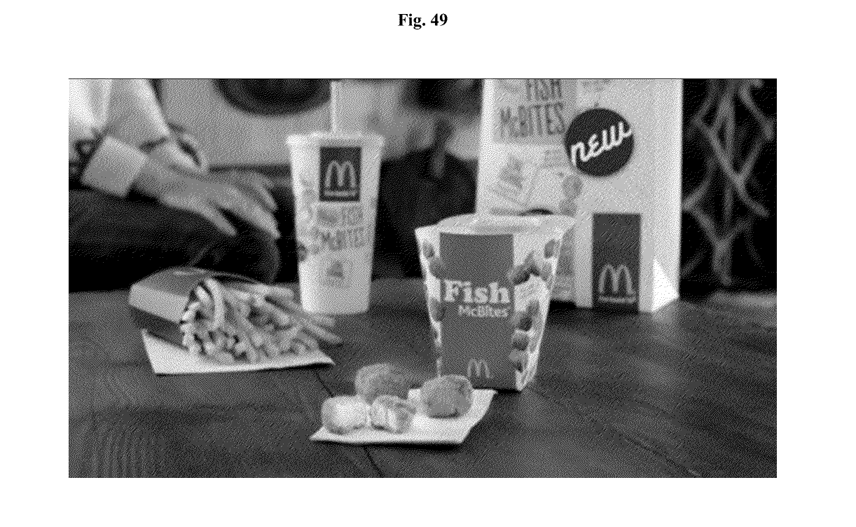

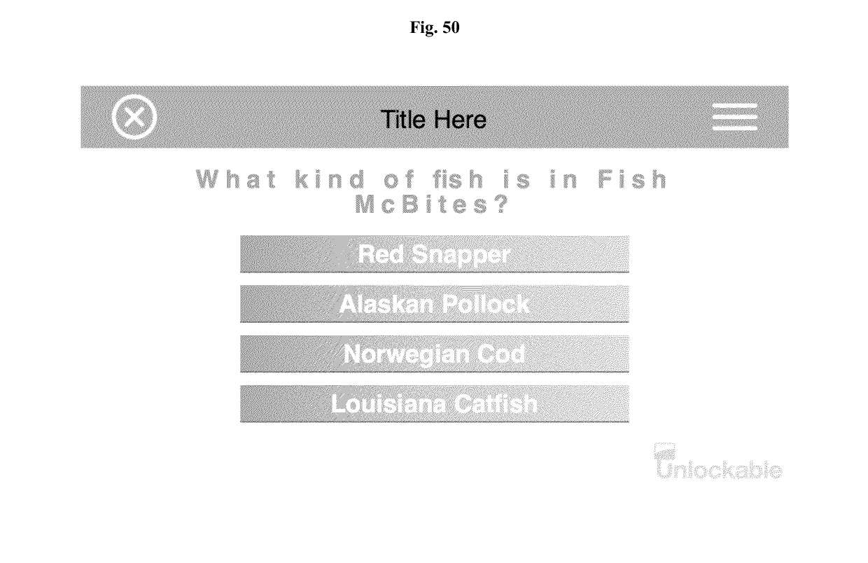

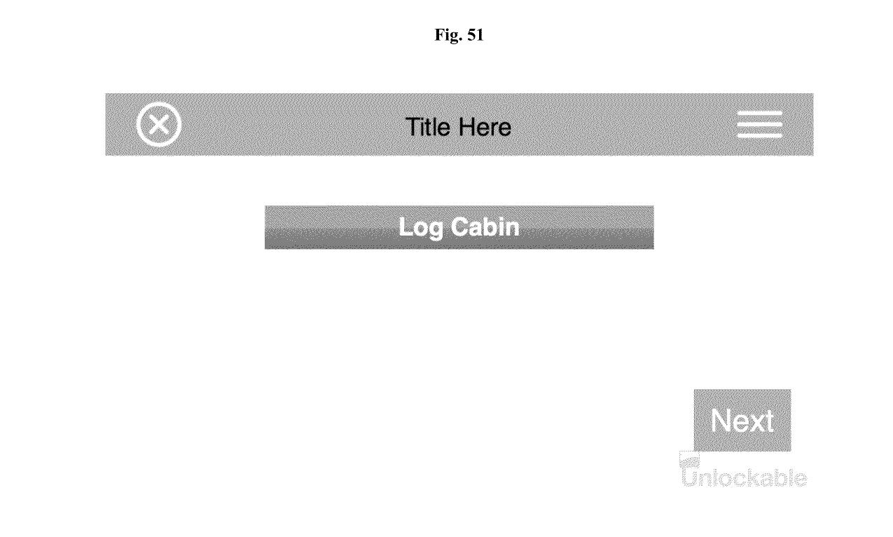

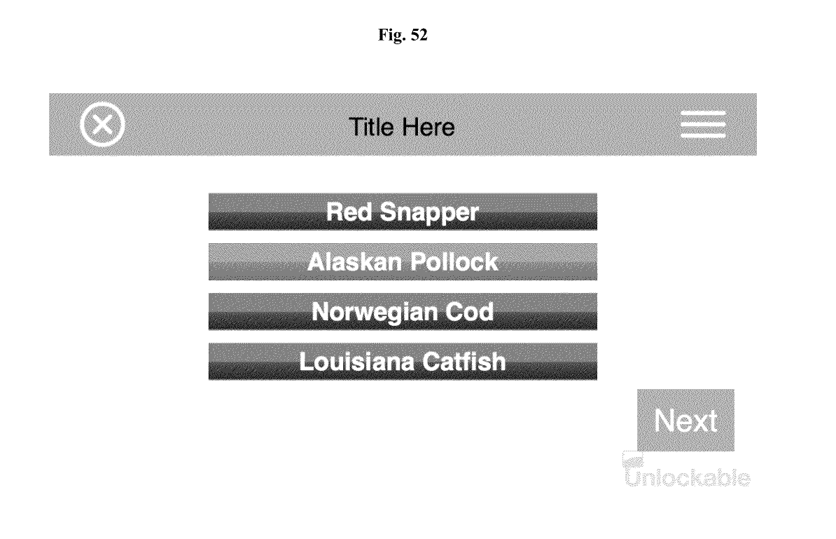

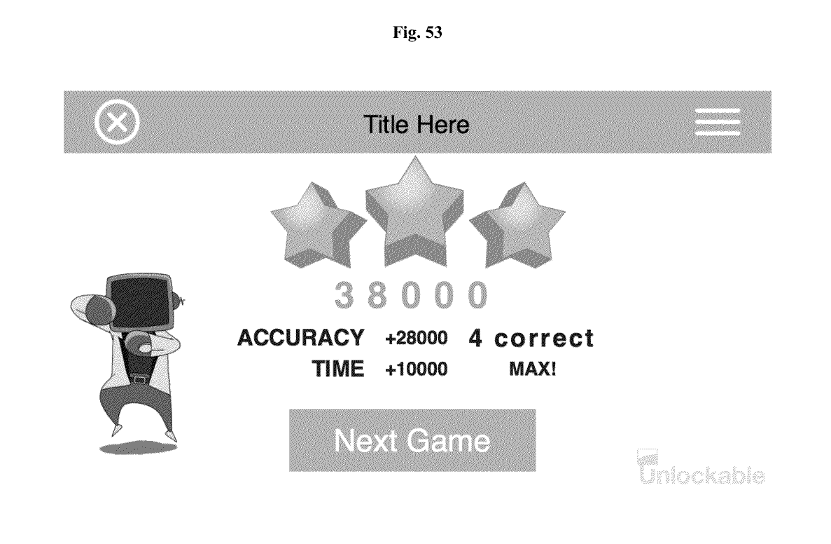

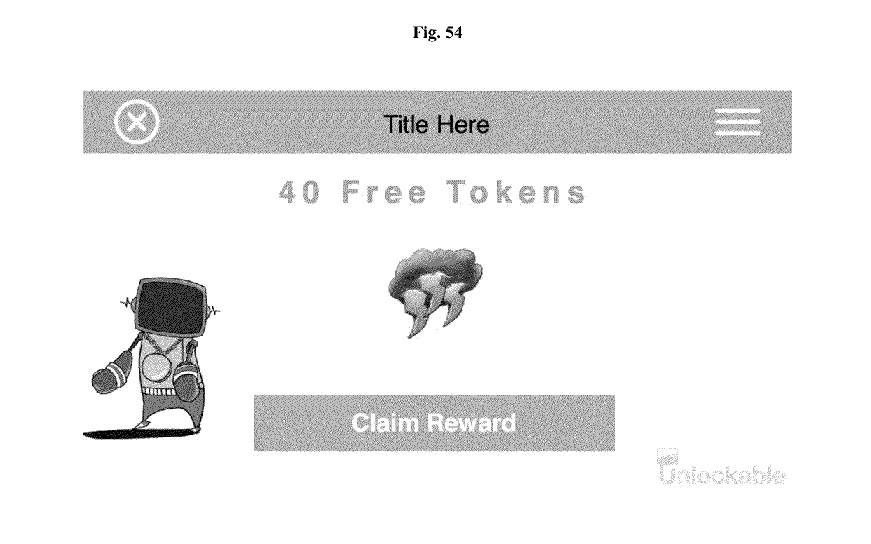

Referring to FIGS. 42-54, in a particular embodiment, the Unlockable application is presented on a mobile or tablet device. FIG. 47 shows a non-limiting example of a pathfinder survey question that asks a user a question to collect information, such as but not limited to: demographics, behavior and interests. Upon answering the question, the user is awarded with points that count towards one or more completion criteria to access the media good, service or information. The user is also presented the option to skip answering the pathfinder survey question.

In some embodiments, the platforms, systems, media, and methods described herein include a software module configured to create a playlist of games. In further embodiments, a playlist of games comprises a sequence of games. In still further embodiments, the specific games and their order of presentation are selected for a particular user via a playlisting algorithm. Many criteria are suitable for selection of a game or a game sequence for a particular user. For example, in various embodiments, suitable criteria include, by way of non-limiting examples, demographic information of the user (e.g., age, gender, income, location, education, etc.), requested good, service, or information, environment from which the user requested access to a particular good, service, or information, user behavioral actions (e.g., browsing history, etc.), user survey results, and user historical game play (e.g., games played, number of plays, performance of play, accumulated points/tokens, etc.).

### Game Play and Rewards

In some embodiments, the platforms, systems, media, and methods described herein include a software module configured to track user game play, or use of the same. In further embodiments, a software module configured to track user game play tracks, by way of non-limiting examples, game identity, game difficulty, number of plays, duration of play, score, other measures of user performance (e.g., correct and incorrect interactions, etc.), and the like. In still further embodiments, a software module configured to track user game play tracks one or more user demographic or user behavioral parameters.

In some embodiments, game play value is represented by points or tokens and the platforms, systems, media, and methods described herein include a software module configured to award points or tokens for user game play. In some embodiments, users are authenticated and tracking user game play includes tracking an accumulated point or token total. In some embodiments, users are provided with a reward when their game play achieves a threshold value. Rewards suitably take many forms.

In some embodiments, a first class of rewards includes the item a player intends to unlock, which is presented after game play is finished (e.g., a TV episode from Amazon). In further embodiments, points or tokens are redeemable for the goods, services, and/or pieces of information identified by the user. In other words, points or tokens are redeemable for the item the user desires to access and intends to unlock.

In some embodiments, a second class of rewards includes offers that come from each individual brand, which are presented during the game after each ad (e.g., “Great job on the Coca Cola puzzle! Here is a $1 coupon!”). For example, a user could receive many brand offers en route to unlocking an identified item, depending on how many ads they see and how many games they play. In such embodiments, rewards associated with the ad are awarded as bonuses and do not involve exchanging any points for them. In these embodiments, the brand reward is for completing that brand's ad, not necessarily for earning a specific number of points.

In some embodiments, a third class of rewards includes those selected from a catalog of rewards. As used herein, a “catalog” refers to any list or collection of goods, services, and/or information. Suitable catalogs of rewards include those assembled by providers of the systems, media and methods described herein as well as those assembled by third parties. In some embodiments, a catalog suitably includes goods, services, or information related to the subject matter of ads and/or games. In other embodiments, a catalog suitably includes goods, services, or information unrelated to the subject matter of ads viewed and/or games played. In a particular embodiment, a suitable catalog of rewards is provided by an e-storefront. By way of example to demonstrate a catalog of rewards, a user fills their account (e.g., wallet, etc.) with virtual currency or credits and spends it on rewards offered in a web-based or app-based catalog, in one or more third-party catalogs, or in physical or digital stores. In such embodiments, the rewards may or may not be related to a particular good, service, or piece of information identified by a user or the subject matter of any particular ad/game.

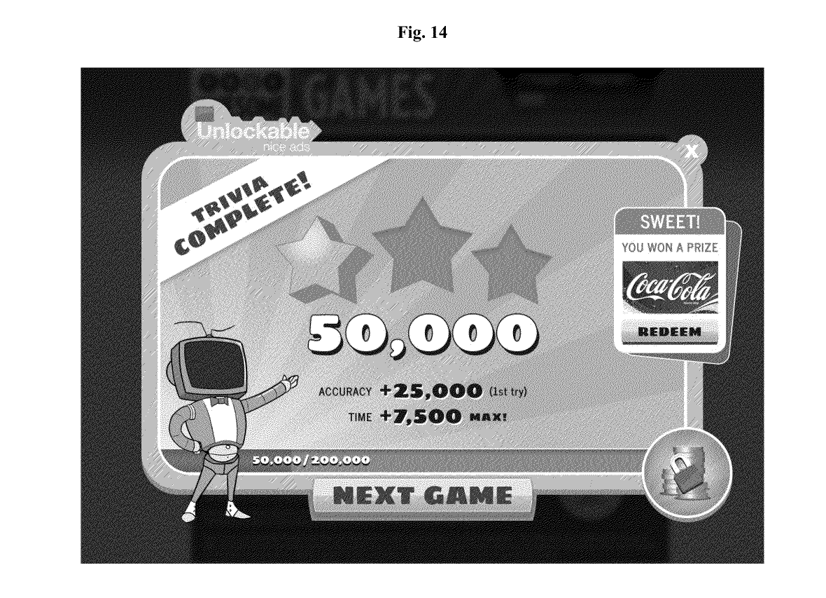

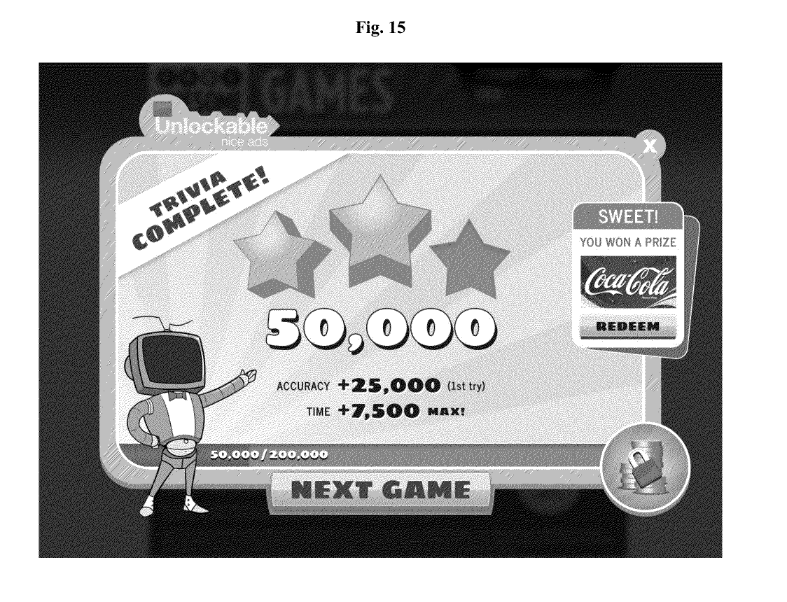

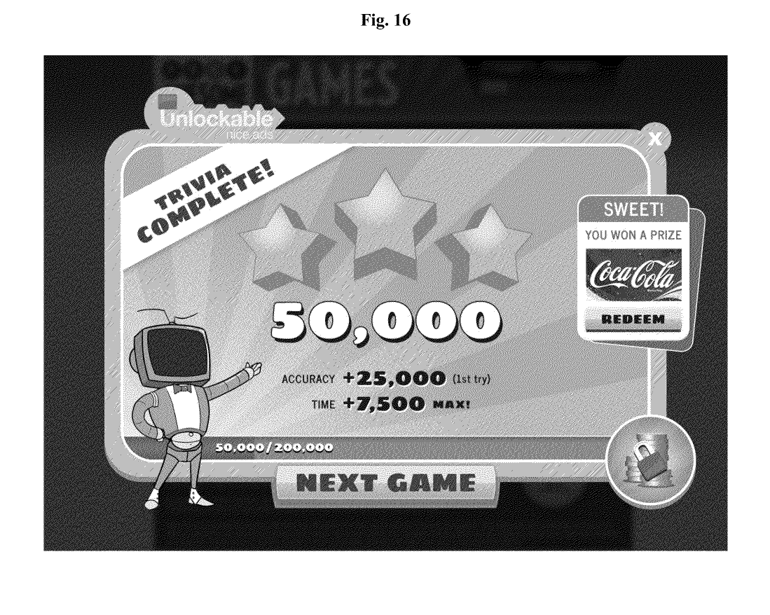

Referring to FIGS. 14-16, in particular embodiments, an ad-based trivia game described herein includes a screen congratulating the user for completion of the game. In these embodiments, feedback provided is based on user performance and points are awarded. Further, in these embodiments, the screen includes a bonus reward; in these cases, a coupon redeemable for a good associated with the subject matter of the ad.

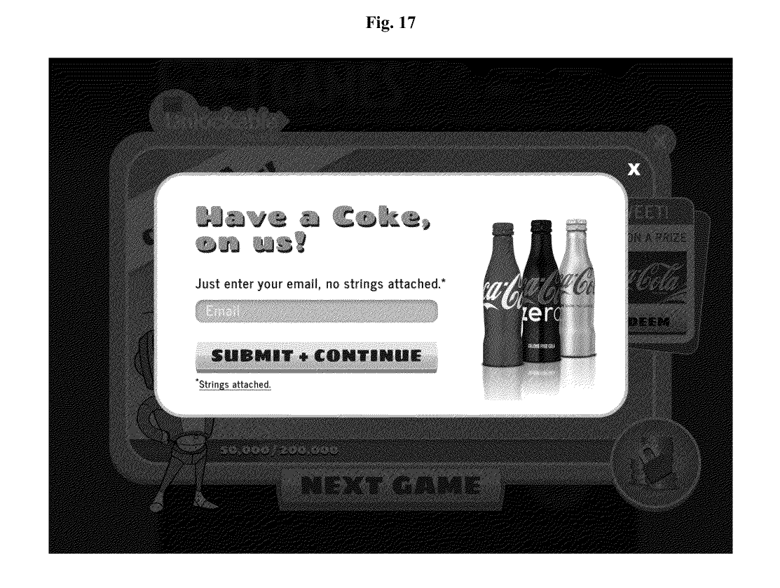

Referring to FIG. 17, in a particular embodiment, an ad-based game includes a screen for redeeming a bonus reward for goods associated with the subject matter of the ad.

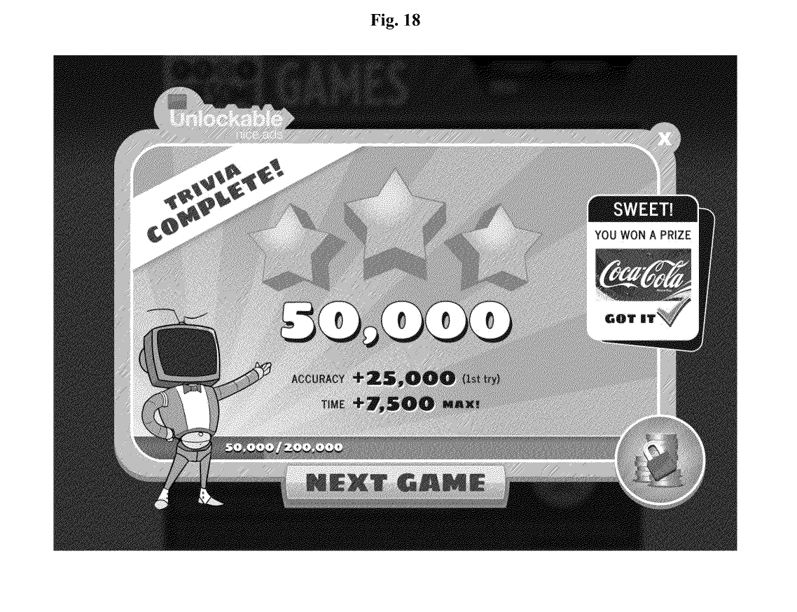

Referring to FIG. 18, in a particular embodiment, a screen congratulating the user for completion of the game includes an indicator that a bonus reward has been redeemed.

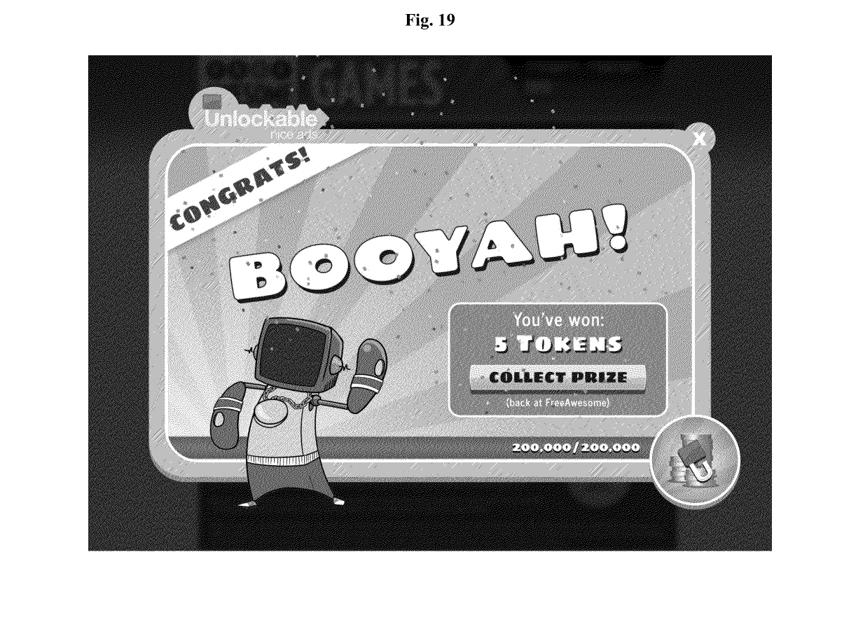

Referring to FIG. 19, in a particular embodiment, an ad-based game described herein tracks user game play and awards tokens based on user performance. In this embodiment, a users token total has achieved a threshold necessary to unlock a user-identified good, accordingly, the interface includes a button to access the good.

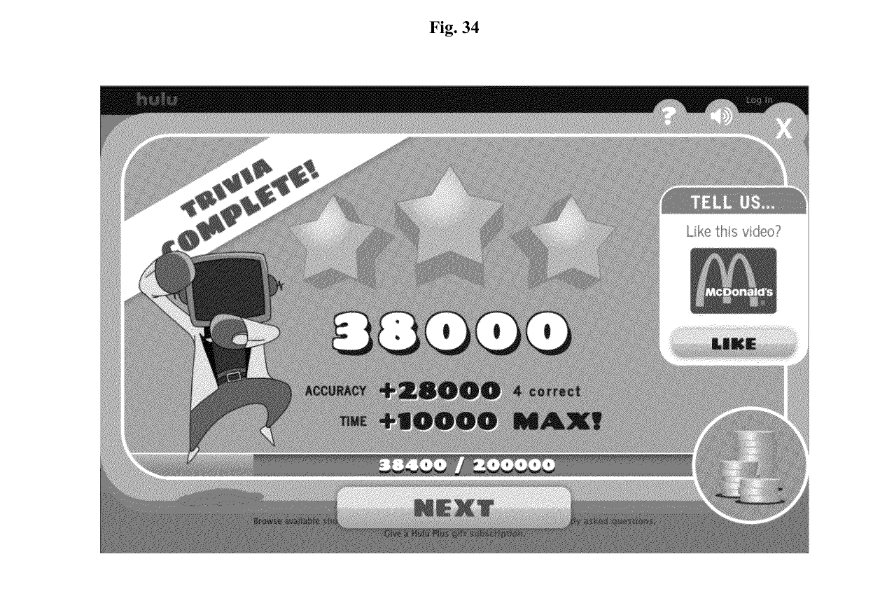

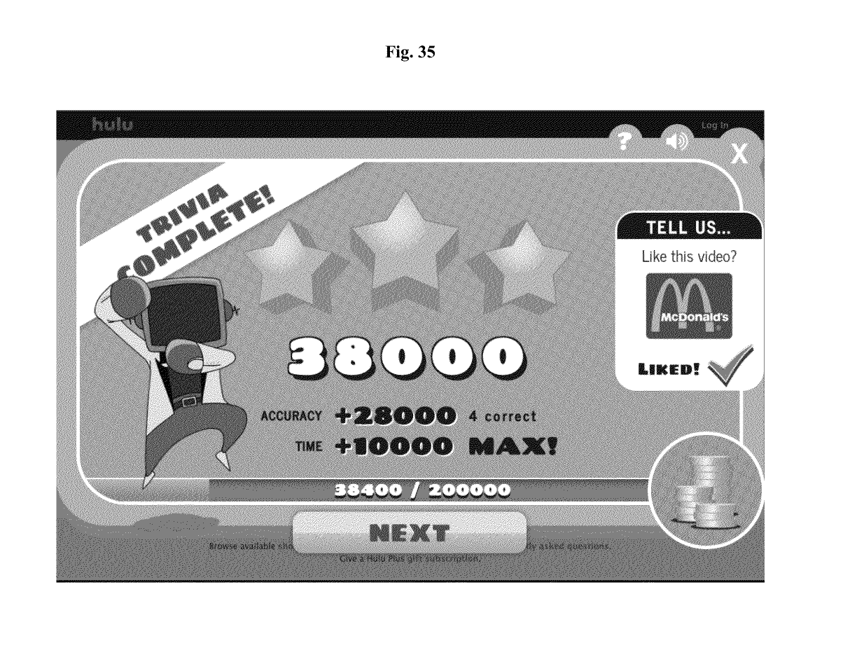

Referring to FIGS. 34 and 35, in a particular embodiment, upon completion of a trivia game play, the user is presented with points gained during the trivia game play that counts towards an example of one completion criteria, a numeric point threshold. In this case, the numeric point threshold is 200,000, shown at the bottom of the screen. An option to the right is also presented, by way of non-limiting example, a button to “like” the video ad that was played is provided to the user. See, e.g., FIG. 34. If this option is selected, there is visual feedback to show confirmation. See, e.g., FIG. 35. In this embodiment, the performance screen is presented after each and every ad-based game a user plays.

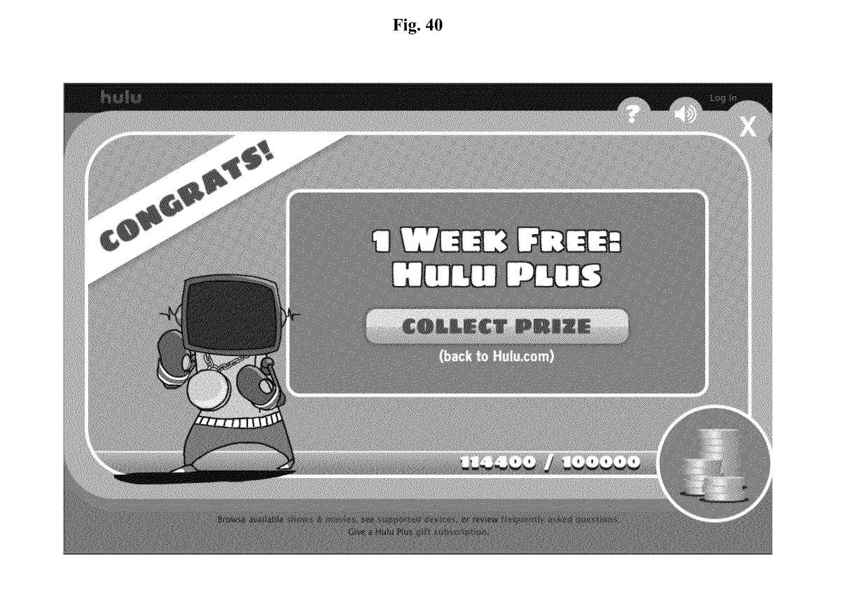

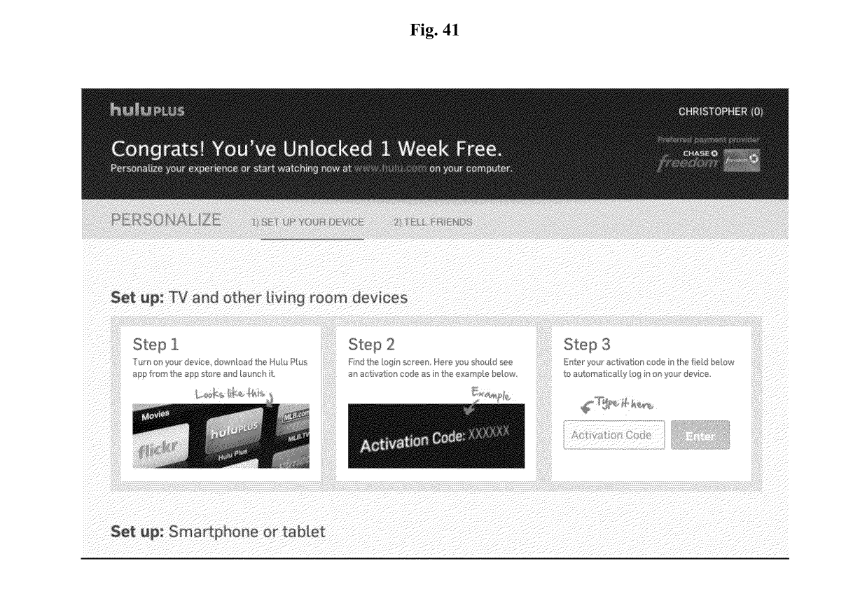

Referring to FIGS. 40-41, in a particular embodiment, the user has satisfied at least one completion criteria, in this case, the point threshold of 100,000. The user is presented with a button to return to the media provider's website or application, where the media good, service or information may be awarded. See, e.g., FIG. 41.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Those of skill in the art will also recognize that select devices and appliances with optional computer network connectivity (i.e., “the Internet of Things”) are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile OS, Linux®, and Palm® WebOS®. Those of skill in the art will also recognize that suitable media streaming device operating systems include, by way of non-limiting examples, Apple TV®, Roku®, Boxee®, Google TV®, Google Chromecast, Amazon Fire, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, ad, game, and reward information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising:
a. a digital processing device comprising an operating system configured to perform executable instructions and a memory device;
b. a computer program including instructions executable by the digital processing device to create an application for providing a non-currency alternative to access goods, services, or information comprising:
i. a software module configured to receive input from a user identifying a particular good, service, or information and indicating a request to access the particular good, service, or information via a non-currency alternative payment method;
ii. a software module configured to select a game from a database of games, the game based on an ad;
iii. a software module configured to present the game to the user and track the user's game play; and
iv. a software module configured to provide access to the good, service, or information in response to the user's game play achieving one or more completion criteria.

2. The system of claim 1, wherein the one or more completion criteria comprise: earning a minimum number of points, playing or completing a minimum number of games, or being randomly rewarded an instant win.

3. The system of claim 1, wherein the ad comprises video.

4. The system of claim 1, wherein the ad comprises one or more images.

5. The system of claim 1, wherein the application further comprises a database of ads.

6. The system of claim 1, wherein the application further comprises a software module configured to create a game by applying a game template to ad media.

7. The system of claim 1, wherein the game comprises an interactive ad.

8. The system of claim 1, wherein the goal of the game comprises user demonstration of retention of the content of the ad.

9. The system of claim 8, wherein the retention is assessed by one or more of:
a. answering trivia questions about the content of the ad;
b. sequencing images captured from the content of the ad;
c. matching sound clips to animations or video clips captured from the ad;
d. connecting pieces of playing video together;
e. guiding falling pieces of playing video into the correct positions;
f. rearranging various shapes of video into the proper configuration;
g. selecting predetermined images within the video as the video plays; and
h. clicking or tapping the video after hearing an audio cue.

10. The system of claim 1, wherein the good, service, or information comprises one or more songs, videos, movies, books, magazines, articles, TV shows, software applications, virtual goods, virtual currency, discounts, coupons, physical goods, or a combination thereof.

11. The system of claim 1, wherein the good, service, or information comprises a subscription or portion of a subscription cost for a media provider.

12. The system of claim 11, wherein the media provider is a mobile/tablet application provider, mobile/tablet game provider, cable provider, telecom provider, wireless service provider, broadcast network provider, digital video provider, digital music provider, digital radio provider, terrestrial radio provider, premium channel provider, news editorial provider, magazine editorial provider, ebook provider, subscription provider, or service provider.

13. The system of claim 1, wherein the ad or the game is selected based on collected data.

14. The system of claim 13, wherein the collected data comprises on one or more of:
a. user demographic;
b. environment from which the user requested access to the particular good, service, or information;
c. user behavioral action including app downloads, web browsing history, purchase history, coupon redemptions, or engagement with particular media;
d. attributes or metadata of a particular video ad, the attributes or metadata comprising length, subject matter, or content;
e. external, third party data sources selected from: publicly available information, social networks, shopper loyalty programs, data vendors, and proprietary data companies;
f. user survey results; and
g. user historical game play.

15. The system of claim 1, wherein the software module configured to present the game to the user and track the user's game play tracks number of plays, time, score, accumulated value, and answers to survey questions posed during game play.

16. The system of claim 1, wherein the application further comprises a software module configured to award points or tokens for the user's game play.

17. The system of claim 1, wherein the application further comprises a software module configured to create a playlist of games, the playlist comprising a sequence of games, each game selected for the user.

18. The system of claim 1, wherein the processing device is a public kiosk, a media rental machine, a vehicle, a taxi passenger display, an airplane seatback device, an in-vehicle video display, an internet-enabled appliance, an internet-enabled television, or an automated bank teller machine.

19. Non-transitory computer-readable storage media encoded with a computer program including instructions executable by a processor to create an application for providing a non-currency alternative to access goods, services, or information comprising:
a) a software module configured to receive input from a user identifying a particular good, service, or information and indicating a request to access the particular good, service, or information via a non-currency alternative payment method;
b) a software module configured to select a game from a database of games, the game based on an ad;
c) a software module configured to present the game to the user and track the user's game play; and
d) a software module configured to provide access to the good, service, or information in response to the user's game play achieving one or more completion criteria.

20. A computer-implemented method for providing access to goods, services, or information via a non-currency alternative payment method comprising:
a) receiving, by a computer, input from a user identifying a particular good, service, or information and indicating a request to access the particular good, service, or information via a non-currency alternative payment method;
b) selecting, by the computer, a game from a database of games, the game based on an ad;
c) presenting, by the computer, the game to the user and track the user's game play; and
d) providing, by the computer, access to the good, service, or information in response to the user's game play achieving one or more completion criteria.

21. The method of claim 20, wherein the method further comprises creating, by the computer, a playlist of games, the playlist comprising a sequence of games, each game selected for the user.
